(19) United States
(12) Patent Application Publication
(10) Pub. No.: US 2011/0167372 A1
(43) Pub. Date: Jul. 7, 2011

(54) APPARATUS FOR PROVIDING COMBINATION MODULE DATA

(75) Inventor: Kuniyoshi Iwai, Tokyo (JP)

(73) Assignee: MISUMI CORPORATION, KOTO-KU, TOKYO (JP)

(21) Appl. No.: 13/063,052

(22) PCT Filed: Mar. 15, 2010
(86) PCT No.: PCT/JP2010/054361

§ 371 Date: Mar. 9, 2011

(30) Foreign Application Priority Data
Mar. 16, 2009 (JP) 2009-062638

(51) Int. Cl. G06F 3/048

(52) U.S. Cl. 715/771

(57) ABSTRACT

A combination module (CM) database (21) stores: CM types associated with assembly examples of a plurality of combination modules; a variation map in which constituent component data pertaining to combinations of constituent components in the examples is registered in association with the CM types; and CM information in which CM assembly dimension data is registered in association with the CM types. A retrieval section (31) retrieves, from the CM information registered in association with the input CM type in the combination module database (21), a combination module which has dimensions including essential dimension data minimum required in the design process as the input CM. A display section (5) displays the CM data retrieved by the retrieval section (31).

### PRIORITY CLAIM

The present application is based on and claims the priority benefit of Japanese Patent Application No. 2009-062638 filed on Mar. 16, 2009, the contents of which are incorporated herein by reference in its entirety.

### BACKGROUND OF THE INVENTION

1. Field of the Invention

The present invention relates to an apparatus for providing data pertaining to a combination module obtained by combining a plurality of components to a user.

2. Description of the Related Art

Hitherto, various techniques have been considered for a design aiding apparatus in designing a device of desired functions by combining components. For example, in Japanese Patent Laid-open No. H9-179892 (hereinafter referred to as Patent Document 1), there is disclosed a technique related to a design aiding apparatus which suggests combinations of example components and standard components necessary for designing a required specification.

Specifically, the design aiding apparatus disclosed in Patent Document 1 stores preliminarily a property value range and shape feature data of the standard components, and design information, property information and shape feature data of the example components in a database, retrieves in the database the standard components having property values and shape feature data consistent with those input by a user, the standard components having similar property values and shape feature data or the example components having similar shape features, and suggests the user to have a selection from the retrieved components. The design aiding apparatus repeats the process for a number of times necessary for retrieving the components and associates CAD (Computer Assisted Design) data with each component selected by the user to support the design of the device of desired functions.

Herein, the description is carried out on the design of an apparatus by a FA (factory Automation) system. In the FA system, a device is manufactured by using the components purchased from component makers. Therefore, the designers have to download the CAD data of each component provided by the component makers and assemble the downloaded CAD data piece by piece into an assembly drawing.

The conventional design procedure will be described by using a “stopper & block” which is obtained by combining adjusting screws and stopper blocks to fulfill the function of determining the position to a mobile object as an example with reference to the flow chart in FIG. 29.

The designers confirm the specifications (shapes) of the adjusting screws according to the catalog (STEP S600) and determine the sizes (the diameter of adjusting screw, the pitch and the screw thread degree) of the adjusting screws (STEP S601). The designers confirm the presence of the sizes of the adjusting screws according to a written standard table in the catalogue (STEP S602). In other words, the designers confirm whether or not the sizes of the adjusting screws determined at STEP S601 are present with reference to the written standard table. The designers confirm the specifications (shapes) of the stopper blocks according to the catalog (STEP S603); confirm the specification of the stopper blocks according to a written standard table in the catalogue (STEP S604); and determine the stopper blocks for use (STEP S605).

The designers download the CAD data of the determined stopper blocks from a CAD data providing system of the component makers (STEP S606) and assemble the downloaded CAD data into the assembly drawing.

The designers determine a clearance representing a distance from a stopper block to the mobile object and use the determined clearance as an allowance for the adjusting screw (STEP S607). The designers calculate the total length needed for the adjusting screw according to the determined allowance of the adjusting screw and the specification of the determined stopper block (STEP S608). The designers determine the total length of the adjusting screw with confirmation on the written standard table of the adjusting screws (STEP S609) and determine the adjusting screw to be assembled in the stopper block (STEP S601).

The designers download the CAD data of the determined adjusting screw from the CAD data providing system (STEP S611). Thereafter, the designers assemble the downloaded CAD data into the assembly drawing. Thereby, the design operation of the “stopper & block” is finished.

As described, the designers must select the components with great attention on whether or not it is possible to combine the components and whether or not the device obtained through the combination satisfies the design specification. In other words, the design dimension of the device obtained through the combination of components must be calculated from the dimension of each component, which will require more work if the number of components becomes large.

Further, the more the number of components becomes, the combination will be more complex; there may arise a problem that the design dimension can not be satisfied in the end after the combination of the components or a problem that the same operation must be repeated for several times so as to satisfy the design dimension. Such problems may happen not only when the number of components needed for the design specification is large but also when the selections of components are increased due to abundant supply of components by the component maker.

When the conventional technique disclosed in Patent Document 1 is applied in the design of the described FA system, it is possible for the design aiding apparatus to select the combinable components but impossible for it to determine whether or not the device obtained through combining the selected components satisfies the design dimension. Thereby, although it is possible to save time in selecting the components, the selection of the components satisfying the final design dimension must be judged by the designers. Therefore, even by using the conventional technique disclosed in Patent Document 1, the problem that the designers must always calculate the design dimension of the device obtained through combining the components from the dimension of each component still remains unsolved.

### SUMMARY OF THE INVENTION

The present invention has been accomplished in view of the aforementioned problems, and it is therefore an object of the present invention to provide an apparatus for providing combination module data desired by a user just by the user assigning essential dimension data satisfying a design specification of a desired combination module.

The present invention relates to an apparatus for providing data pertaining to a combination module obtained by combining a plurality of components to a user. The apparatus for providing combination module data of the present invention comprises: a display section configured to display the data to the user; an input section configured to accept data input from the user; a storage section configured to store a combination module database in which assembly example data pertaining to a plurality of assembly examples of the combination modules is registered, and constituent component data pertaining to combinations of constituent components in the assembly examples and assembly dimension data of the combination modules are registered in association with the assembly example data; a selection section configured to select a combination module desired by the user from the data registered in the combination module database and the data input by the user; wherein the assembly dimension data is composed of essential dimension data satisfying a design specification of a combination module required by the user and internal design dimension data containing predetermined dimensions of constituent components of the combination module except the essential dimension data; the input section is configured to allow the user to input data of one assembly example and allow the user to input only the essential dimension data of the assembly dimension data; the selection section is provided with a retrieval section configured to retrieve one combination module having dimensions including the essential dimension data input through the input section from the assembly dimension data registered in the combination module database in association with the assembly example data input by the user; and the retrieval section is configured to present the retrieved combination module data to the user via the display section.

According to the present invention, the combination module database in which assembly example data pertaining to a plurality of assembly examples of the combination modules is registered, and constituent component data pertaining to combinations of constituent components in the assembly examples and assembly dimension data of the combination modules containing essential dimension data which determines a design specification of a combination module required by the user are registered is preliminarily stored in the storage section; the retrieval section retrieves the combination module having dimensions including the essential dimension data input through the input section from the assembly dimension data registered in the combination module database in association with the assembly example data input by the user; and the display section displays the data of the combination module retrieved by the retrieval section.

In other words, the assembly dimension of the combination module contains two kinds of dimension data: essential dimension data satisfying the design specification of a combination module required by the user and the internal design dimension determined by the dimensions of the constituent components of the combination module without depending on the essential dimension data. Based on this point, the internal dimension of the combinable constituent components is calculated, the assembly dimension data containing the calculated internal dimension and the essential dimension data calculated from the dimensions of the constituent components and the constituent component data pertaining to the combinations of the constituent components are preliminarily registered in the combination module database in association with the assembly example data pertaining to the assembly examples of the combination module. That is to say, the constituent components are selected first and the combination modules corresponding to various essential dimension data are prepared preliminarily. When the essential dimension data is input by the user, the combination module satisfying the input essential dimension data is selected from the prepared combination modules for providing to the user.

Thereby, the desired combination module by the user can be provided to the user just by the user assigning the essential dimension data satisfying the design specification of the combination module obtained by combining a plurality of components, which contributes to shortening the design time.

In the invention mentioned above, it is preferred that the components are standard components; and the input section allows the user to select the input data consistent with the standard components.

According to the present invention, the components constituting the combination module are standard components, and the input section is configured to allow the user to select the input data consistent with the standard components. Thereby, the combination module satisfying the input data can be provided with the input of one time instead of being input twice, which contributes to shortening the design time.

It is preferred that the invention mentioned above is further provided with a component database for registering data pertaining to at least the dimensions and materials of the components, and a creation section configured to create the assembly dimension data of the combination module database from the data registered in the component database and the constituent component data registered in the combination module database, wherein the storage section stores the component database; the creation section is provided with a constituent component selection section configured to select components satisfying combination conditions of the constituent components given by the constituent component data registered in the combination module database from the data registered in the component database, and a dimension calculation section configured to calculate the essential dimension data on the basis of the dimensions of the components selected by the constituent component selection section for a combination module specified according to the selected components; and the dimensions including the calculated essential data are registered in the combination module database as the assembly dimension data of the combination module.

According to the present invention, the storage section is further stored with the component database registered with the data pertaining to at least the dimensions and materials of the components; the constituent component selection section is configured to select components satisfying combination conditions of the constituent components given by the constituent component data registered in the combination module database from the data registered in the component database; the dimension calculation section is configured to calculate the essential dimension data on the basis of the dimensions of the components selected by the constituent component selection section for a combination module specified according to the selected components and register the calculated essential dimension data in the combination module database.

Thus, by registering only the assembly example data, the constituent component data and the component database, it is possible to create the combination module and it is also possible to save time in creating the combination module in consideration of the combinations of the components. Moreover, even a new component is added, by registering incrementally the added component into the component database, it is possible to create the combination module with the component as one of the constituent components in a short time.

In the invention mentioned above, it is preferred that the construction section is configured to construct the combination module data containing at least identifiers for identifying the constituent components of the combination module retrieved by the retrieval section.

According to the present invention, the construction section is configured to construct the combination module data containing the identifiers (for example, the model numbers of the constituent components) for identifying the constituent components of the combination module. Thereby, the user can recognize the constituent components of the combination module.

In the invention mentioned above, it is preferred that the storage section is configured to further store a graphics database registered with CAD data of the combination module; and the creation section is configured to include the CAD data of the combination module registered in the graphics database in creating the combination module data.

According to the present invention, the creation section is configured to include the CAD data of the combination module registered in the graphics database in creating the combination module data. Thereby, since the use can acquire the CAD data of the combination module, it is not necessary to acquire the CAD data of the constituent components piece by piece and assemble them into the assembly drawing, which contributes to improving the design efficiency.

### BRIEF DESCRIPTION OF THE DRAWINGS

FIG. 1 is a view illustrating an adjusting screw constituting a combination module “stopper & block”;

FIG. 2 is a view illustrating a stopper block constituting the combination module “stopper & block”;

FIG. 3 is a view illustrating the configuration of the combination module “stopper & block”;

FIG. 4 is a block view illustrating the configuration of an apparatus for providing combination module according to the present invention;

FIG. 5 is a view illustrating an example of module information registered in the combination module DB illustrated in FIG. 4;

FIG. 6 is a view illustrating an example of a variation map registered in the combination module DB illustrated in FIG. 4;

FIG. 7 is a view illustrating an example of module information registered in the combination module DB illustrated in FIG. 4;

FIG. 8 is a view illustrating an example of component information registered in the component DB illustrated in FIG. 4;

FIG. 9 is a view illustrating an example of component information registered in the component DB illustrated in FIG. 4;

FIG. 10 is a flow chart illustrating operations of a combination selecting process of the apparatus for providing combination module according to a first embodiment;

FIG. 11 is a view illustrating an example of a module selecting screen displayed by the display section illustrated in FIG. 4;

FIG. 12 is a view illustrating an example of a sub-module selecting screen displayed by the display section illustrated in FIG. 4;

FIG. 13 is a view illustrating an example of a variation selecting screen displayed by the display section illustrated in FIG. 4;

FIG. 14 is a view illustrating an example of a parameter inputting screen displayed by the display section illustrated in FIG. 4;

FIG. 15 is a flow chart illustrating operations of the retrieval process in the flow chart of FIG. 10;

FIG. 16 is a view illustrating an example of a retrieval result screen displayed by the display section illustrated in FIG. 4;

FIG. 17 is a flow chart illustrating operations of a combination module creation-registration process of the apparatus for providing combination module of the first embodiment;

FIG. 18 is a view illustrating a supporting column constituting the combination module “sensor stand”;

FIG. 19 is a view illustrating a supporting column's clamp constituting the combination module “sensor stand”;

FIG. 20 is a view illustrating a supporting column's stand constituting the combination module “sensor stand”;

FIG. 21 is a view illustrating the configuration of the combination module “sensor stand”;

FIG. 22 is a view illustrating an example of a variation map registered in the combination module DB illustrated in FIG. 4;

FIG. 23 is a view illustrating an example of module information registered in the combination module DB illustrated in FIG. 4;

FIG. 24 is a view illustrating an example of component information registered in the component DB illustrated in FIG. 4;

FIG. 25 is a view illustrating an example of component information registered in the component DB illustrated in FIG. 4;

FIG. 26 is a view illustrating an example of component information registered in the component DB illustrated in FIG. 4;

FIG. 27 is a flow chart illustrating operations of a retrieval process of the combination module according to a second embodiment;

FIG. 28 is a flow chart illustrating operations of a combination module creation-registration process of the apparatus for providing combination module of a second embodiment; and

FIG. 29 is a flow chart illustrating operations of a combination module creation-registration process of the apparatus for providing combination module of a conventional art.

### DETAILED DESCRIPTION OF THE PREFERRED EMBODIMENTS

Hereinafter, an embodiment of an apparatus for providing combination module according to the present invention will be described in detail with reference to the drawings. The present invention is not limited to the embodiment.

[Summary and Features]

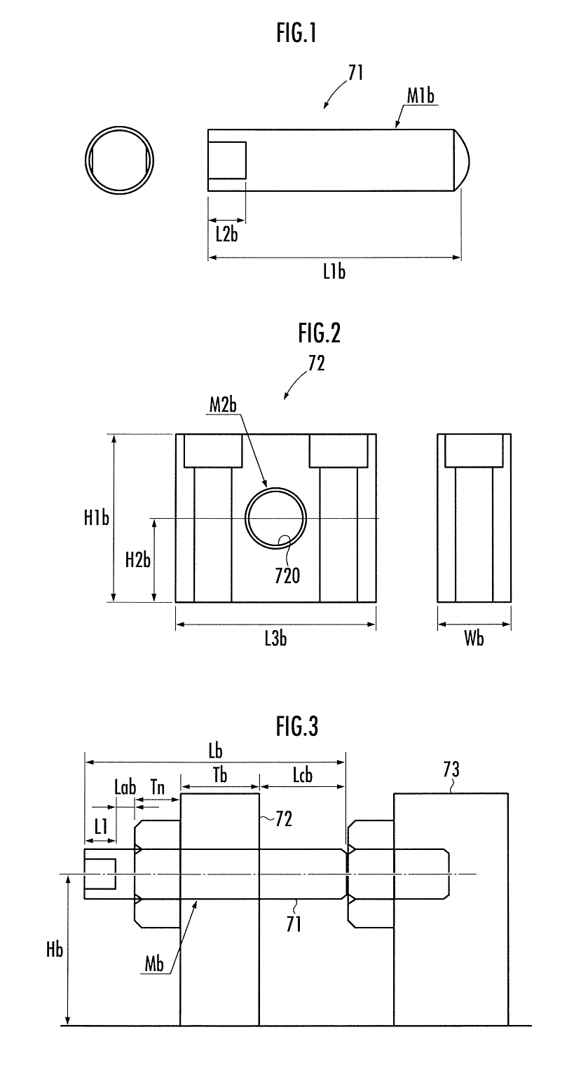

Firstly, a combination module provided by the apparatus for providing combination module according to the present invention will be described. In the present invention, a combination module refers to a component composite obtained by combining a plurality of components to fulfill a desired function. A “stopper & block” serves as one example of positioning function in FA (Factory Automation) system. The “stopper & block” is obtained by combing an adjusting screw 71 in FIG. 1 and a stopper block 72 in FIG. 2 to fulfill the function of determining the position to a mobile object.

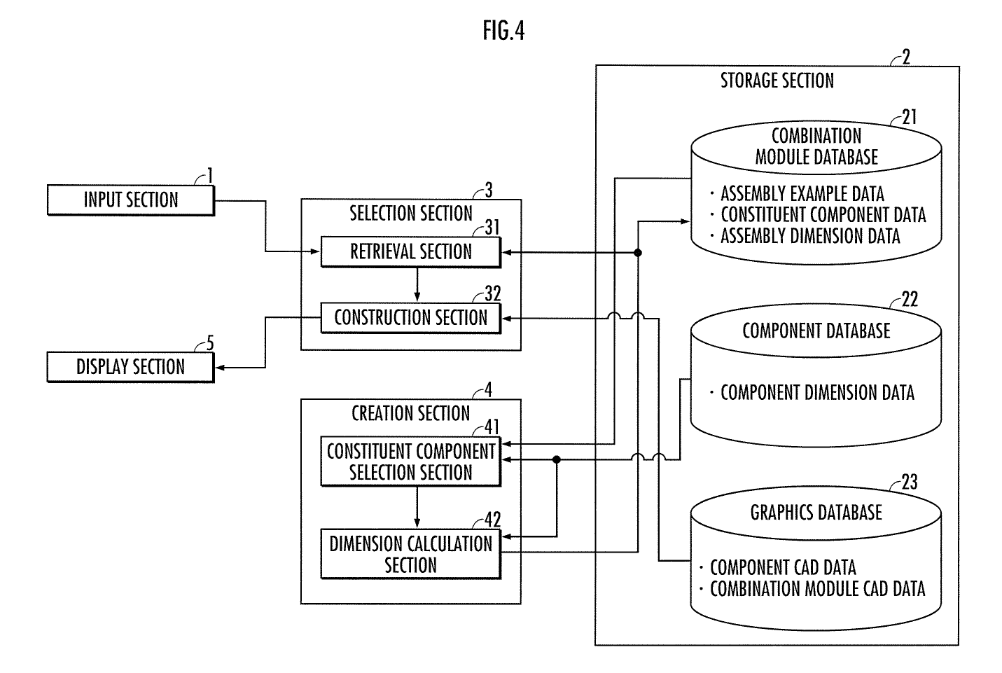

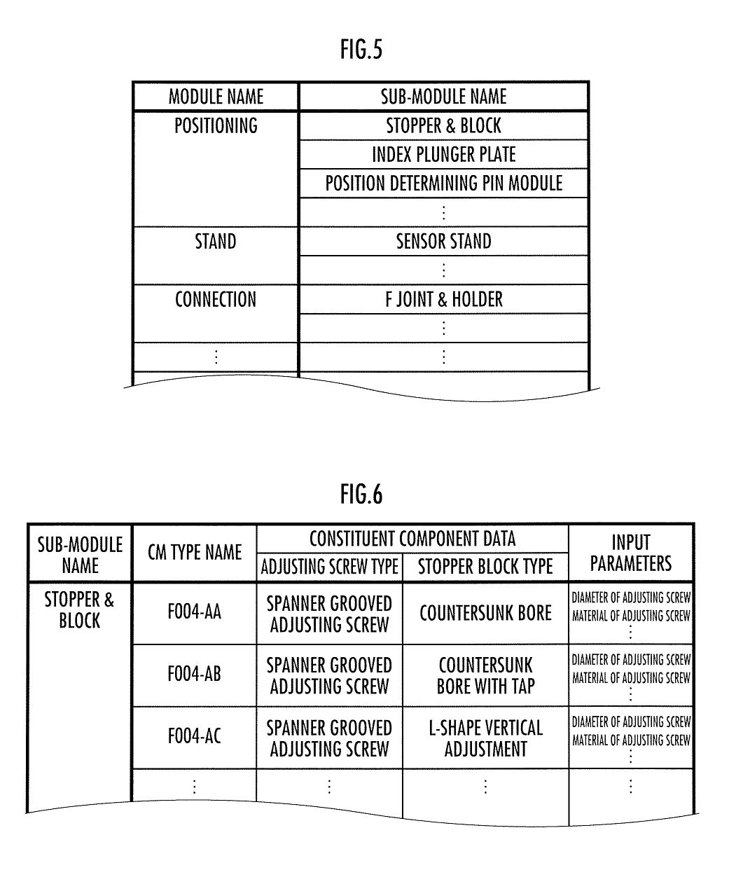

FIG. 3 illustrates the configuration of the “stopper & block”. In FIG. 3, the “stopper & block” is obtained by assembling the adjusting screw 71 in the previous FIG. 1 to an adjusting screw fixing pore 720 disposed in the stopper block 72 in the previous FIG. 2 to determine the position to the mobile object 73. The design specification of the “stopper & block” includes the specification such as the materials and surface treatments of the adjusting screw 17 and the stopper block 72, and the design dimensions. The design dimensions of the “stopper & block” include a clearance Lcb denoting the distance from the stopper block 72 to the mobile object 73, a screw size (screw diameter, pitch screw and thread degree) Mb of the adjusting screw 71, a dimension (the height of the adjusting screw) Hb from the fixing surface of the stopper block to the center of the adjusting screw 71, the thickness Tb of the stopper block, a length Lb of the adjusting screw and so on. Among the design dimensions, the design dimension determining the function of the “stopper & block”, in other words, the essential dimension data minimum required in design process are the clearance Lcb, the screw size Mb and the height of adjusting screw Hb.

Meanwhile, when a designer (user) selects the adjusting screw and the stopper block from a plurality of components to design the “stopper & block”, attention must be paid not only on the essential dimension data of the “stopper & block” but also on the internal design dimension necessary for combining the components (design dimension necessary for combing the components).

Specifically, the component dimension of the adjusting screw 71 in FIG. 1 includes the length (screw length) L1b of the adjusting screw 71, the screw size M1b, the length (fastening portion length) L2b of a fastening portion (spanner groove, a bolt head or the like) of the screw, and the height of an accessory component such as a nut and the like. The component dimension of the stopper block 72 in FIG. 2 includes the height (block height) H1b of the stopper block 72, the length (stopper block length) L3b, the width (stopper block width) Wb, the size (screw diameter, pitch and screw thread degree) M2b of an adjusting screw fixing pore 720, a dimension from the fixing surface to the center of the adjusting screw fixing pore 720 (the adjusting screw fixing height H2b, herein H2b=H1b/2).

As mentioned above, the essential dimension data of the “stopper & block” includes the clearance Lcb, the screw size Mb and the height of adjusting screw Hb. The screw size Mb is determined by the screw size M1b of the adjusting screw 71 and the adjusting screw fixing pore M2b of the stopper block 72. The height of adjusting screw Hb is determined by the adjusting screw fixing height H2b (=H1b/2) of the stopper block 72. However, the clearance Lcb must be obtained by calculating the internal design dimension from the length L1b of a selected adjusting screw, the fastening portion length of the adjusting screw L1, the stopper block thickness Wb, the nut height Tn and the adjusting width Lab in fixing. The calculation becomes complex as the combinations of the components become more. According the calculation result, sometimes the calculation of the internal design dimension may not satisfy the essential dimension data; thus, it is necessary to redo the design from the selection of components again. In other words, attention must be always paid on the internal design dimension to select the length of the adjusting screw 71 satisfying the clearance Lcb. Specifically, the clearance Lcb can be obtained by the following equation 1.

Lcb=Lb−(L1+Lab+Tn+Tb) (Equation 1)

Wherein, Lb: the length of adjusting screw; L1: the fastening portion length of adjusting screw; Lb: the length of adjusting screw; Lab: the adjusting width; Tn: the nut height of adjusting screw; Tb: the thickness of stopper block.

According to the equation 1, the length Lb of the adjusting screw can be expressed by the following equation 2.

Lb=Lcb+L1+Lab+Tn+Tb (Equation 2)

Herein, the clearance Lcb is the essential dimension data of the combination module “stopper & block” and “L1+Lab+Tn+Tb” is the internal dimension for obtaining the clearance Lcb. The internal dimension is not dependant on the essential dimension data of the combination module but determined by the dimensions of the constituent components of the combination module.

Based on the point that the internal design dimension is determined by the dimensions of the constituent components of the combination module without depending on the essential dimension data of the combination module, the apparatus for providing combination module of the present invention creates preliminarily combination modules corresponding to various essential dimension data, and provides a combination module satisfying the design specification including the essential dimension data input from the user.

### First Embodiment

A first embodiment of the apparatus for providing combination module according to the present invention will be described with reference to FIG. 1 through FIG. 17. In the first embodiment, the combination module “stopper & block” is given as an example for description.

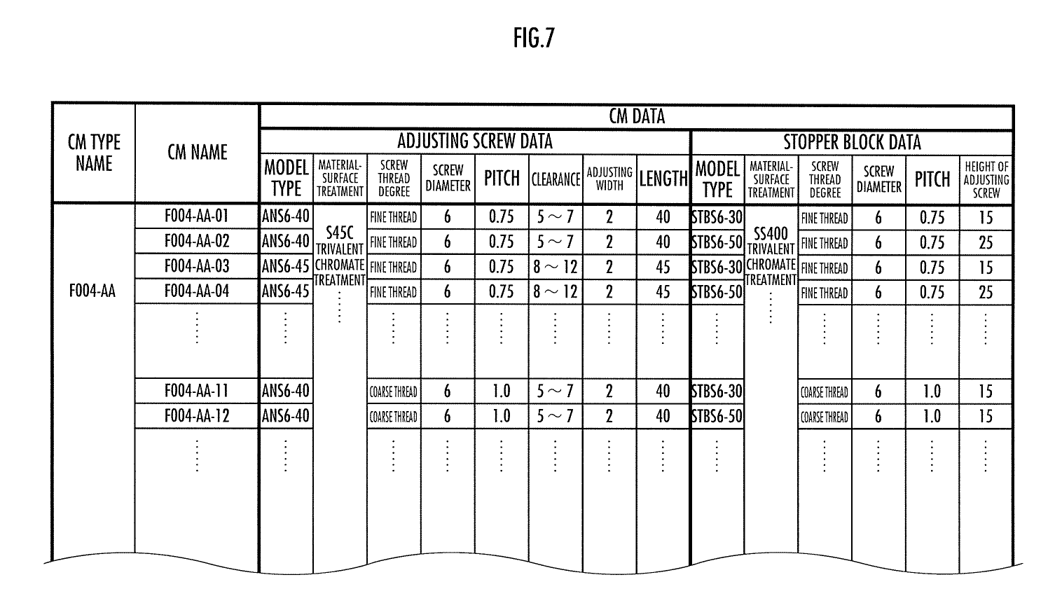

FIG. 4 is a block view illustrating the configuration of the apparatus for providing combination module according to the present invention. The apparatus for providing combination module in FIG. 4 is provided with an input section 1, a storage section 2 for storing a combination module database (hereinafter, referred to as combination module DB) 21, a component database (hereinafter, referred to as component DB) 22 and a graphics database (hereinafter, referred to as graphics DB) 23, a selection section 3 having a retrieval section 31 and a construction section 32, a creation section 4 having a constituent component selection section 41 and a dimension calculation section 42, and a display section 5.

The input section 1 is composed of general input devices such as a keyboard, a mouse and the like, and functions as an input unit for accepting data input when retrieving the combination module or registering data in the combination module DB 21.

In the combination module DB21, the assembly example data pertaining to assembly examples of the combination modules is registered, and the constituent component data pertaining to combinations of the constituent components in the assembly examples and the assembly dimension data of the combination modules are registered in association with the assembly example data.

Specifically, in the combination module DB 21, module information, a variation map and combination module information (hereinafter, referred to as CM information), which will be described later, are registered. The module information is registered with information pertaining to modules classified according to the functions of the combination modules.

FIG. 5 illustrates one example of the module information. In FIG. 5, module name and sub-module name are registered as registration items of the module information. In the module name, the names of modules divided roughly according to the main functions of the combination module are registered; and in the sub-module name, the names of sub-modules further divided according to the functions of the combination module belonging to each module registered in the module name.

The combination module in FIG. 5 is supposed to be used in FA (Factory Automation). The module name is registered with “positioning”, “stand”, “connection” . . . . ; the sub-module name belonging to the module “positioning” is registered with “stopper & block”, “index plunger plate”, and “position determining pin module”; the sub-module name belonging to the module “stand” is registered with “sensor stand” . . . . ; and the sub-module name belonging to the module “connection” is registered with “F joint & holder” . . . .

The variation map is registered in association with the sub-module names of the module information registered in the module information in the previous FIG. 5. The variation map is a map registered with combination module type (referred to as CM type hereinafter) belonging to the associated sub-module name, the constituent component data pertaining to the combination of components used in the CM type, and the design specification (input parameters) necessary for selecting the combination modules from the CM type. The CM type is equivalent to the assembly example data described in the claims, and is a general term of a combination module in which the shapes of components constituting the combination module are the same but the design specifications thereof (for example, materials, surface treatment, design dimension and the like) are different. The input parameters contain at least the material, the surface treatment and the essential dimension data of the constituent components of the combination module.

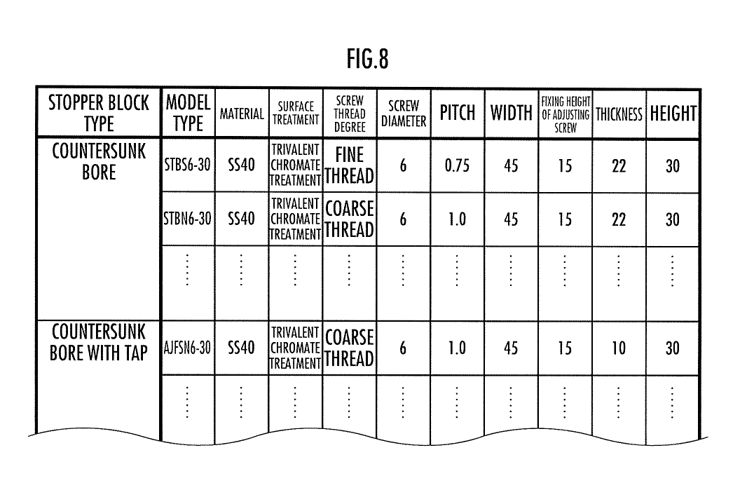

FIG. 6 illustrates one example of the variation map associated with the sub-module “stopper & block”. In FIG. 6, the sub-module name, the CM type name registered with identifiers for identifying the CM types, the constituent component data registered with data pertaining to combinations of components used in the CM types registered in the CM type name, and the input parameter registered with various data items of the design specification to request the user are registered as the registration items of the variation map. The registration items of the constituent component data is registered with “adjusting screw type” in which the shapes of the adjusting screws being the constituent components of the sub-module “stopper & block” are registered and “stopper block type” in which the shapes of the stopper blocks being the constituent components of the sub-module “stopper & block” are registered. In FIG. 6, the input parameter is registered with “the diameter of adjusting screw, the material of adjusting screw . . . ”, however, in fact the input parameter is registered with the material, the surface treatment, the diameter, the pitch and the screw thread degree of adjusting screw, and the material, the surface treatment, the width, the height and the length of the stopper block, the clearance to the mobile object and the height of adjusting screw. The essential dimension data are the clearance to the mobile object, the height of adjusting screw and the adjusting screw size (screw diameter, pitch, and screw thread degree).

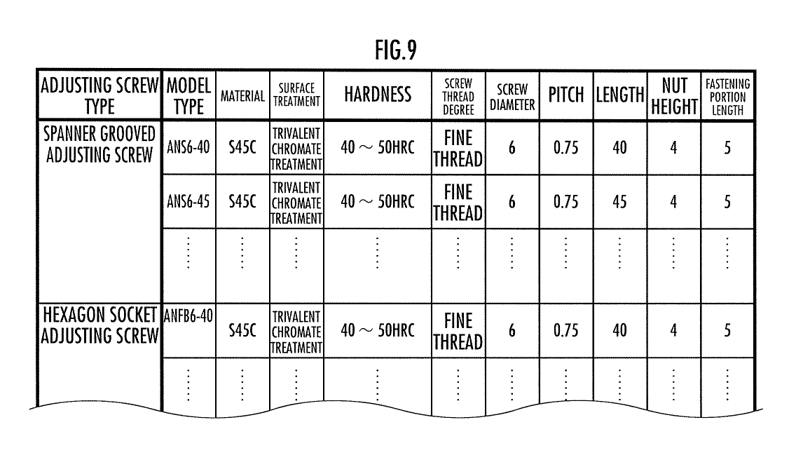

The CM information is registered with information of the combination module belonging to the CM type in association with the CM type of the variation map in the previous FIG. 6. The assembly dimension data including the essential dimension data minimum required in design process is contained in the CM information as the combination module. FIG. 7 illustrates one example of the CM information of the combination module associated with the CM type “F004-AA”. In FIG. 7, the CM type name registered with the CM types, the combination module name (referred to as CM name hereinafter) registered with identifiers for identifying the combination modules belonging to the CM types, and the combination module data (referred to as CM data hereinafter) registered with information associated with the combination modules registered in the CM name are registered as the registration items of the CM information. The adjusting screw data and the stopper block data, both are the constituent components of the combination module, are registered as the registration items of the CM data.

The model type, the material-surface treatment, the screw thread degree, the diameter of adjusting screw, the pitch, the clearance, the adjusting width and the length are registered as the registration items of the adjusting screw data. The model type is registered with identifiers (model types) for identifying the components of the adjusting screw. The material-surface treatment is registered with the materials and the surface treatment of the adjusting screws registered in the model type. The screw thread degree is registered with the classifications of screw thread degree of the adjusting screws registered in the model type. The diameter of adjusting screw is registered with the diameters of the adjusting screws registered in the model type. The pitch is registered with the pitches of the adjusting screws registered in the model type. The clearance is registered with the clearance to the mobile object of “stopper & block”. The adjusting width is registered with the adjusting widths for determining the lengths of the adjusting screws. The length is registered with the lengths of the adjusting screws registered in the model type.

The model type, the material-surface treatment, the screw thread degree, the diameter of adjusting screw, the pitch, and the height of adjusting screw are registered as the registration items of the stopper block data. The model type is registered with identifiers (model types) for identifying the components of the stopper block. The material-surface treatment is registered with the materials and the surface treatment of the stopper blocks registered in the model type. The screw thread degree is registered with the classifications of screw thread degree of the adjusting screw fixing pores of the stopper blocks registered in the model type. The diameter is registered with the diameter of the adjusting screw fixing pore of the stopper blocks registered in the model type. The pitch is registered with the pitches of the adjusting screw fixing pores of the stopper blocks registered in the model type. The height of adjusting screw is registered with the adjusting screw fixing heights of the stopper blocks registered in the model type.

In the CM information of FIG. 7, the screw thread degree, the diameter of adjusting screw, the pitch, the clearance, and the height of adjusting screw in the stopper block data are the essential dimension data.

Referring back to FIG. 4, the component DB 22 is registered with data pertaining to the dimensions and materials of various components associated with the constituent component data of various variation maps registered in the combination module DB 21.

The components registered in the component DB 22 include not only the components which have been written in the catalog but also those components which have not been written in the catalog (will be written in the catalog in the future) but could be provided to the user. In the present invention, the components registered in the component DB 22 are called as standard components.

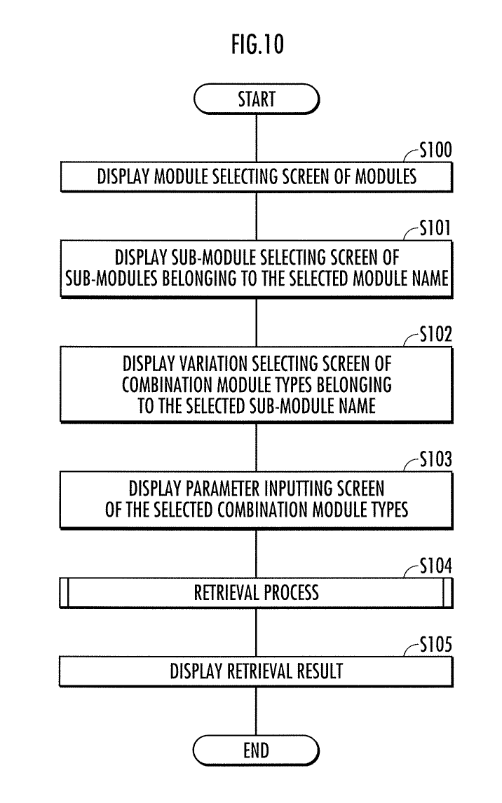

FIG. 8 and FIG. 9 illustrate examples of the component information registered in the component DB 22, respectively. FIG. 8 illustrates one example of the component information associated with the “stopper block type”. In FIG. 8, the stopper block type, the model type, the material, the surface treatment, the screw thread degree, the diameter, the pitch, the width, the adjusting screw fixing height, the thickness and the height are registered as the registration items of the component information associated with the “stopper block type”.

The stopper block type is registered with the types of the stopper blocks in the constituent component data of the sub-module “stopper & block” in the previous FIG. 6. The model type is registered with identifiers (model types) for identifying the components having the shapes of the stopper block types registered in the stopper block type. The material is registered with the materials of the components registered in the model type. The surface treatment is registered with the surface treatments of the components registered in the model type. The screw thread degree is registered with the classifications of screw thread degree of the adjusting screw fixing pores of the stopper blocks registered in the model type. The diameter is registered with the diameter of the adjusting screw fixing pores of the stopper blocks registered in the model type. The pitch is registered with the pitches of the adjusting screw fixing pores of the stopper blocks registered in the model type. The width is registered with the width of the stopper blocks registered in the model type. The width is registered with the width of the stopper blocks registered in the model type. The adjusting screw fixing height is registered with the adjusting screw fixing height of the stopper blocks registered in the model type. The height is registered with the heights of the stopper blocks registered in the model type.

FIG. 9 illustrates one example of the component information associated with the “adjusting screw type”. In FIG. 9, the adjusting screw type, the model type, the material, the surface treatment, the hardness, the screw thread degree, the diameter of adjusting screw, the pitch, the length, the nut height and the fastening portion length are registered as the registration items of the component information.

The adjusting screw type is registered with the types of the adjusting screws in the constituent component data of the sub-module “stopper & block” in the previous FIG. 6. The model type is registered with identifiers (model types) for identifying the components having the shapes of the adjusting screw types registered in the adjusting screw type. The material is registered with the materials of the adjusting screws registered in the model type. The surface treatment is registered with the surface treatments of the adjusting screws registered in the model type. The hardness is registered with the hardness of the adjusting screws registered in the model type. The screw thread degree is registered with the classifications of screw thread degree of the adjusting screws registered in the model type. The diameter of adjusting screw is registered with the diameters of the adjusting screws registered in the model type. The pitch is registered with the pitches of the adjusting screws registered in the model type. The length is registered with the length of the adjusting screws registered in the model type. The nut height is registered with the nut heights of the adjusting screws registered in the model type. The fastening portion length is registered with the length of the fastening portion of the adjusting screws registered in the model type.

The registration items of the component information illustrated in FIG. 8 and FIG. 9 mention only the necessary items for describing the operations of the apparatus for providing combination module of the first embodiment; thereby, in practical use, it is acceptable to include the entire information in the written standard table of the catalog as the registration items.

Referring back to FIG. 4, the graphics DB 23 is registered with the CAD data of the combination modules and the components. Each CAD data is registered in the graphics DB 23 in association with the combination names of the combination modules and the model types of the components. The CAD data may be 2D CAD data or 3D CAD data. In the present embodiment, the CAD data is registered with both 2D CAD data and 3D CAD data.

The selection section 3 selects a combination module having the dimensions including the essential dimension data input by the user through the input section 1 from the CM information registered in the combination module DB 21. Moreover, the selection section 3 allows the information pertaining to the selected combination module to be displayed on the display section 5.

The selection section 3 is provided with the retrieval section 31 and the construction section 32. The retrieval section 31 retrieves the combination module having the dimensions including the essential dimension data input by the user through the input section 1 from the CM information registered in the combination module DB 21. The construction section 32 allows the identifiers (model types) for identifying each of the components constituting the combination module retrieved by the retrieval section 31 and the CAD data of the combination module registered in the graphics DB 23 to be displayed on the display section 5.

The creation section 4 creates the CM information from the component information registered in the component DB22 and the variation maps registered in the combination module DB 21, and registers the created CM information in the combination module DB 21.

The creation section 4 is provided with the constituent component selection section 41 and the dimension calculation section 42. The component selection section 41 selects the components satisfying the combination conditions of the constituent component data of the variation maps registered in the combination module DB 21 from the component information registered in the component DB 22.

The dimension calculation section 42, on the basis of the dimensions of the components selected by the constituent component selection section 41, calculates the essential dimension data of the combination module obtained from the selected components.

The display section 5 is composed of a liquid display, a CRT (Cathode-Ray Tube), a printer and the like for displaying the data (displaying the input screen for inputting parameters or the retrieval results and so on) delivered from the selection section 3.

Hereinafter, the operation of the apparatus for providing combination module according to the first embodiment will be described. The operation of the apparatus for providing combination module according to the first embodiment includes a combination module selection process for retrieving and displaying a combination module consistent with the requirements of the user and a combination module creation-registration process performed by the administrators to create the CM information of the combination module and register the created CM information in the combination module DB 21.

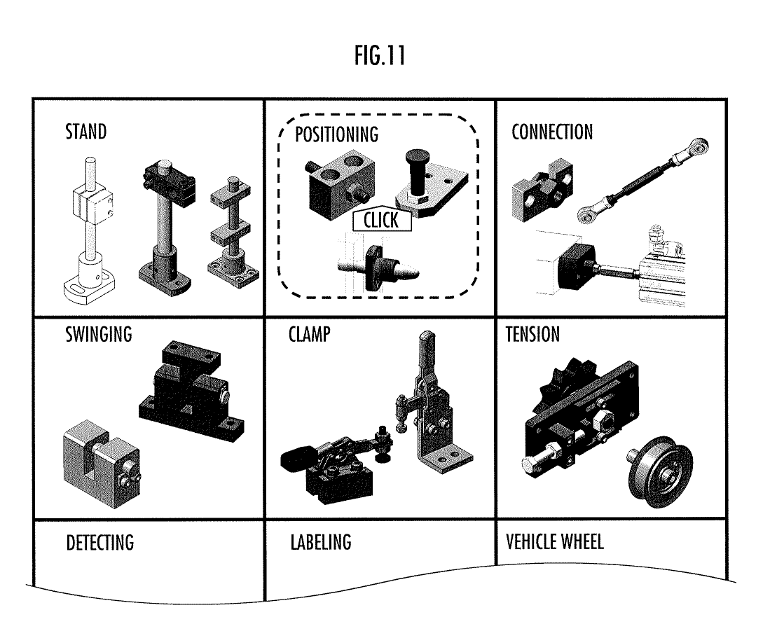

First, the operation of the combination module selection process will be described. FIG. 10 is a flow chart illustrating the operation of the combination module selection process performed by the apparatus for providing combination module of the first embodiment. After accepting the retrieval request of a combination module input by the user through the input section 1, the selection section 3 creates the display data of the module selecting screen for the user to select the module and displays the display data of the created module selecting screen on the display section 5 (STEP S100).

Specifically, the selection section 3 acquires the entire module names from the module information (refer to FIG. 5) registered in the combination module DB 21 and creates the display data of the module selecting screen including the acquired module names. The selection section 3 delivers the display data of the created module selecting screen to the display section 5. The display section 5 displays the display data of the delivered module selecting screen.

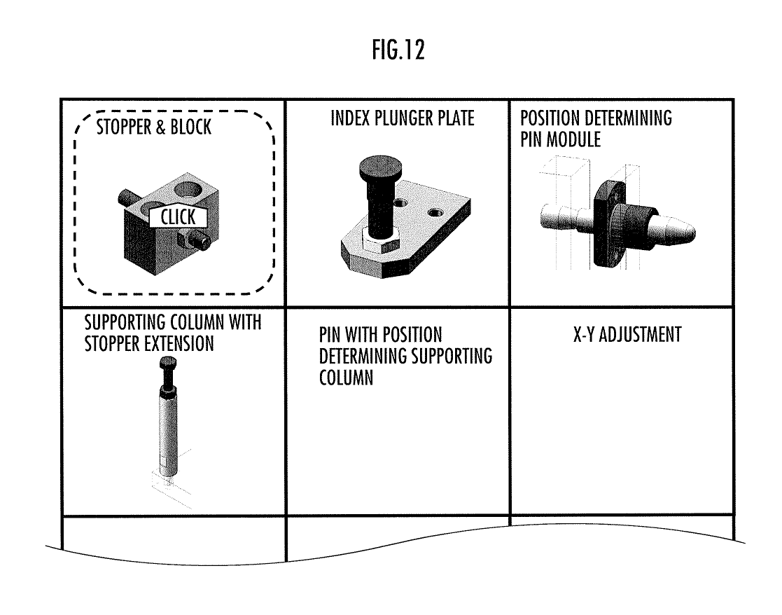

FIG. 11 illustrates one example of the module selecting screen displayed on the display section 5. In FIG. 11, the module names and the graphics of the sub-module belonging to each module name are displayed. In this case, it is acceptable to store preliminarily the display data of the module selecting screen in the storage section 2 and the selection section 3 reads out the display data of the module selecting screen stored in the storage section 2 and delivers it to the display section 5. However, the module selecting screen is not limited thereto; it is acceptable that it contains at least information by which the module name can be recognized.

The user selects the desired function from the module names displayed on the display section 5 and inputs the selected module name through the input section 1. Herein, the module “positioning” is input.

The selection section 3 creates the display data of the sub-module selecting screen for the user to select the sub-module belonging to the module name selected by the user through the input section 1 and allows the display data of the created sub-module selecting screen to be displayed on the display section 5 (STEP S101).

Specifically, the selection section 3 retrieves, from the module names of the module information (refer to FIG. 5) registered in the combination module DB 21, the module name consistent with the input module name, and acquires the entire sub-module names registered in the module information in association with the input module name. Herein, the input module name is the module “positioning”; thus, the selection section 3 acquires the sub-module names of “stopper & block”, “index plunger plate”, “position determining pin module” . . . registered in the module information in association with the input module “positioning”. The selection section 3 creates the display data of the sub-module selecting screen including the acquired sub-module names. The selection section 3 delivers the display data of the created sub-module selecting screen to the display section 5. The display section 5 displays the display data of the delivered sub-module selecting screen.

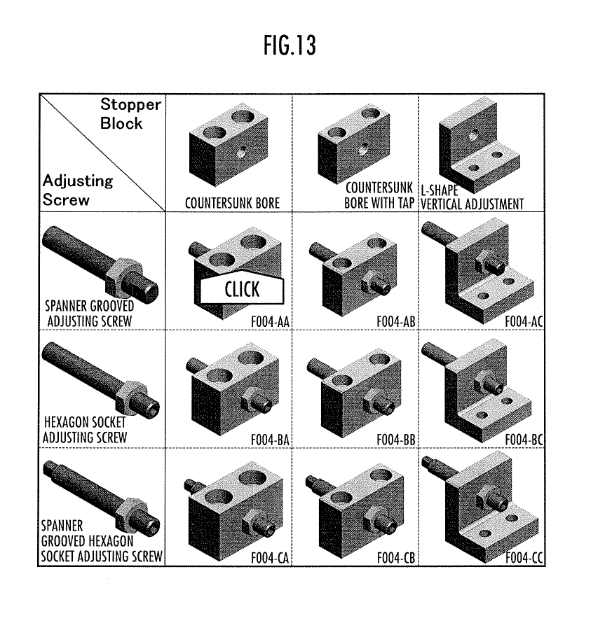

FIG. 12 illustrates one example of the sub-module selecting screen displayed on the display section 5. In FIG. 12, the sub-module name and the graphics of the sub-module are displayed. In this case, it is acceptable to store preliminarily the display data of the sub-module selecting screen in the storage section 2 in association with the module name and the selection section 3 reads out the display data of the sub-module selecting screen stored in the storage section 2 in association with the input module name and delivers it to the display section 5. However, the sub-module selecting screen is not limited thereto; it is acceptable that it contains at least information by which the sub-module name can be recognized.

The user selects the desired function from the sub-module names displayed on the display section 5 and input the selected sub-module name through the input section 1. Herein, the sub-module “stopper & block” is input.

The selection section 3 creates the display data of the variation selecting screen in which variations of the CM types are displayed for the user to select the CM type belonging to the sub-module name input by the user through the input section 1 and allows the display data of the created variation selecting screen to be displayed on the display section 5 (STEP S102).

Specifically, the selection section 3 retrieves, from the variation maps (refer to

FIG. 6) registered in the combination module DB 21, the variation map in which the sub-module name registered in the sub-module name is consistent with the input sub-module name by the user, and acquires the entire CM types and the constituent components of the variation map associated with the input sub-module name. Herein, the sub-module “stopper & block” is selected; thus, as illustrated in FIG. 6, the selection section 3 acquires the CM types of “F004-AA”, “F004-AB”, “F004-AC” . . . associated with the sub-module name “stopper & block” and the adjusting screw types and the stopper block types of the constituent component data associated with each of the CM types.

The selection section 3 creates the display data of the variation selecting screen of the combination module including the acquired combination module types, the adjusting screw types and the stopper block types. The selection section 3 delivers the display data of the created variation selecting screen to the display section 5. The display section 5 displays the display data of the delivered sub-module selecting screen.

FIG. 13 illustrates one example of the variation selecting screen displayed on the display section 5. In FIG. 13, the graphics of the adjusting screw types, the stopper block types and the combination types are displayed. In this case, it is acceptable to store preliminarily the display data of the variation selecting screen in the storage section 2 in association with the sub-module name and the selection section 3 reads out the display data of the variation selecting screen stored in the storage section 2 in association with the input sub-module name and delivers it to the display section 5. However, the variation selecting screen is not limited thereto; it is acceptable that it contains at least information by which the CM type and the types of the constituent components pertaining to the CM type can be recognized.

The user selects the desired combination of the CM types from the CM types displayed on the display section 5 and input the selected CM type through the input section 1. Herein, the CM type “F004-AA” is input.

The selection section 3 creates the display data of the parameter inputting screen for the user to input necessary parameters (the design specification from the user) for retrieving the combination module belonging to the selected CM types and allows the display data of the created parameter inputting screen to be displayed on the display section 5 (STEP S 103).

Specifically, the selection section 3 acquires the input parameters associated with the input CM type from the variation map (refer to FIG. 6) registered in the combination module DB 21. Herein, the input parameters associated with the CM type “F004-AA” is acquired. In detail, the selection section 3 acquires the material, the surface treatment, the diameter of adjusting screw, the pitch and the screw thread degree of the adjusting screw, the material, the surface treatment, the width, the height and the length of the stopper block, the clearance to the mobile object and the height of adjusting screw as the input parameters.

The selection section 3 creates the display data of the parameter inputting screen for the user to input each item of the acquired parameters. The selection section 3 delivers the display data of the created parameter inputting screen to the display section 5. The display section 5 displays the display data of the delivered parameter inputting screen.

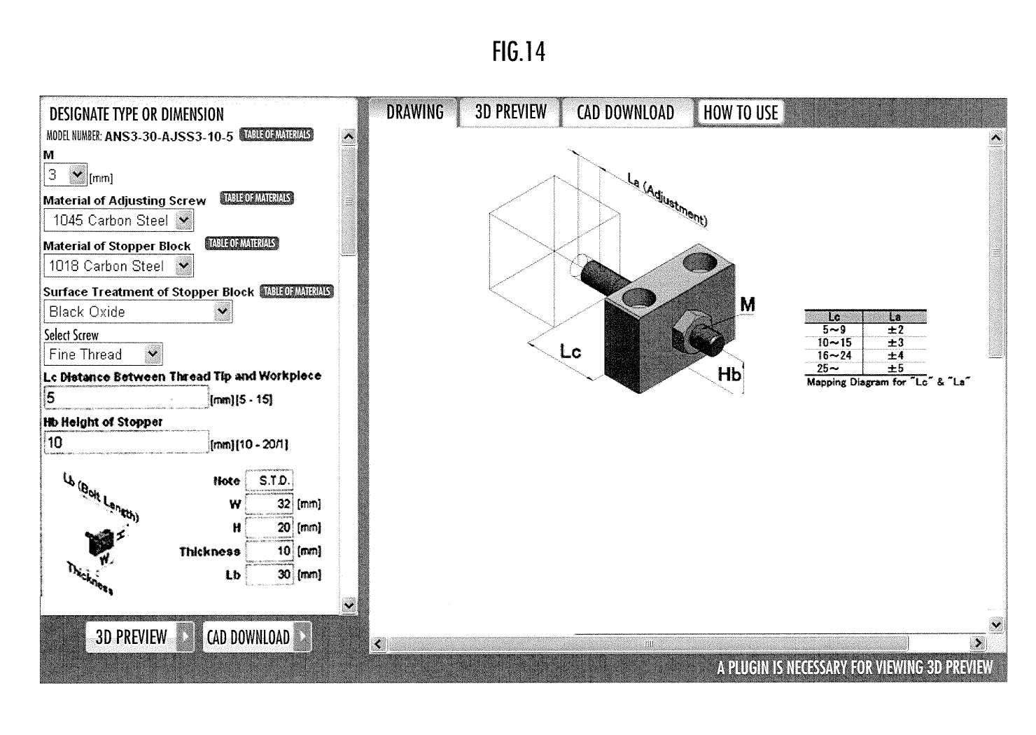

FIG. 14 illustrates one example of the parameter inputting screen displayed on the display section 5. In FIG. 14, the input screen for inputting the material, the surface treatment, the diameter of adjusting screw, the pitch and the screw thread degree of the adjusting screw, the material, the surface treatment, the width, the height and the length of the stopper block, the clearance to the mobile object and the height of adjusting screw are displayed together with the graphic data. However, the parameter inputting screen is not limited thereto, it may be one allowing inputting at least the items registered in the input parameters of the variation map.

The user inputs the desired design specification from the input section 1 according to the parameter inputting screen displayed on the display section 5.

It is acceptable for the selection section 3 to limit the input data in creating the display data of the parameter inputting screen. In this case, the selection section 3 takes the components (standard components) registered in the component DB 22 as the constituent components of the combination module, creates the display data of the parameter inputting screen displaying the values for each dimension of the standard components and displays it on the display section 5. The user selects the input data from the values displayed on the display section 5 and input the selected input data through the input section 1. In other words, the input section 1 allows the user to select the input data consistent with the standard components.

The selection section 3 performs a retrieval process for retrieving the combination modules satisfying the input design specification from the CM information registered in the combination module DB 21 (STEP S104).

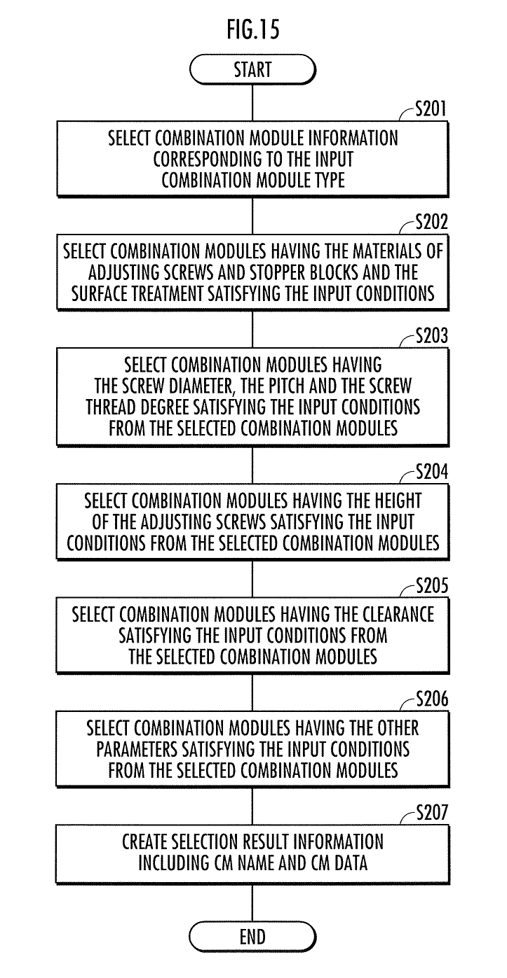

The detailed operation of the retrieval process performed by the retrieval section 31 disposed in the selection section 3 will be described with reference to the flow chart of FIG. 15 by using the CM type “F004-AA” as an example. The retrieval section 31 selects the CM information corresponding to the input CM type input by the user through the variation selecting screen from the CM information registered in the combination module DB 21 (STEP S201). Specifically, the retrieval section 31 uses the input CM type as a retrieval key for retrieving the CM type name of the CM information registered in the combination module DB 21, and acquires the CM information consistent with the retrieval key and the CM type registered in the CM type name.

The retrieval section 31 selects the entire combination modules having the material-surface treatment of the adjusting screw and the stopper block consistent with the input conditions from the acquired CM information (STEP S202). Specifically, the retrieval section 31 uses the combination of the material-surface treatment of the adjusting screw and the material-surface treatment of the stopper block, both are input by the user from the parameter inputting screen, as the retrieval key for retrieving the material-surface treatment of the adjusting screw data and the material-surface treatment of the stopper block data from the CM information, and selects the entire CM names associated with the material-surface treatment of the adjusting screw data and the material-surface treatment of the stopper block data consistent with the retrieval key.

The retrieval section 31 selects the entire combination modules having the diameter, the pitch and the screw thread degree of the adjusting screw consistent with the input conditions from the combination modules selected at STEP S202 (STEP S203). Specifically, the retrieval section 31 uses the combination of the diameter, the pitch and the value of the screw thread degree of the adjusting screw input by the user from the parameter inputting screen as the retrieval key for retrieving the diameter of adjusting screw, the pitch and the screw thread degree of the adjusting screw data associated with the CM names representing the selecting combination modules, and selects the entire CM names associated with the diameter, the pitch and the screw thread degree of the adjusting screw data consistent with the retrieval key.

The retrieval section 31 selects the entire combination modules having the height of adjust screw consistent with the input conditions from the combination modules selected at STEP S203 (STEP S204). Specifically, the retrieval section 31 uses the value of the height of adjusting screw as the retrieval key to retrieve the height of the stopper block data associated with the CM names representing the selected combination modules, and selects the entire CM names associated with the height of the stopper block data consistent with the retrieval key.

The retrieval section 31 selects the entire combination modules having the clearance consistent with the input conditions from the combination modules selected at STEP S204 (STEP S205). Specifically, the retrieval section 31 uses the value of the clearance input by the user from the parameter inputting screen as a retrieval key to retrieve the clearance of the adjusting screw data associated with the CM names representing the selected combination modules, and selects the entire CM names associated with the clearance of the adjusting screw data consistent with the retrieval key.

The retrieval section 31 selects the combination modules consistent with the other input conditions from the combination modules selected at STEP S205 (STEP S206). Specifically, the retrieval section 31 acquires the CM data associated with the CM names representing the selected combination modules. The retrieval section 31 acquires the component information associated with the model types registered in the model type of the adjusting screw data and the stopper block data from the acquired CM data. The retrieval section 31 determines whether or not the design specification (herein, referring to the width, the height and the thickness of the stopper block) except the material, the surface treatment, the diameter of adjusting screw, the pitch and the screw thread degree of the adjusting screw, the material, the surface treatment of the stopper block, the height of adjusting screw, and the clearance to the mobile object is consistent with the component information of the adjusting screw and the component information of the stopper block from the design specification input by the user. In more detail, the retrieval section 31 determines whether or not the width, the height and the thickness of the input stopper block are consistent with the width, the height and the thickness of the acquired component information (refer to FIG. 8) of the stopper block. According to the determination result, the combinations modules registered with the model type of the adjusting screw and the model type of the stopper block consistent with the entire conditions are selected.

In other words, the retrieval section 31, on the basis of the design specification input by the user, selects the combination modules with the material and the surface treatment satisfying the requirements of the user at STEP S202; at STEP S203, selects the combination modules with the diameter, the pitch and the screw thread degree of the adjusting screw satisfying the requirements of the user from the combination modules selected on the basis of the material and the surface treatment; at STEP S204, selects the combination modules with the height of adjusting screw satisfying the requirements of the user from the combination modules selected on the basis of the diameter, the pitch and the screw thread degree of the adjusting screw; at STEP S205, selects the combination modules with the clearance satisfying the requirements of the user from the combination modules selected on the basis of the height of adjusting screw; at STEP S206, selects the combination modules satisfying the other requirements input by the user from the combination modules selected on the basis of the clearance, refines the CM information of the combination modules satisfying the design specification required by the user from the CM information registered in the combination module DB 21, and finally selects one combination module having the essential dimension data satisfying the design specification required by the user. However, the selection order is not limited thereto.

After the combination module satisfying the entire conditions is selected, the retrieval section 31 acquires the CM name of the selected combination module and the CM data associated with the combination module registered in the CM name, and creates the selection result information including the CM name and the acquired CM data (STEP S207). The retrieval process is terminated after the retrieval section 31 delivers the created selection result information to the construction section 32.

Referring back to FIG. 10, after the retrieval process by the retrieval section 31 is terminated; the construction section 32 accepts the selection result information, creates the display data of the retrieval result screen on the basis of the selection result information, and displays the retrieval result on the display section 5 (STEP S105).

Specifically, the construction section 32 acquires the CAD data associated with the CM name contained in the selection result information from the graphics DB23. Moreover, the construction section 32 acquires the component information registered in the component DB 22 associated with the model types (herein, refer to the model types of the adjusting screw and the stopper block) included in the CM data. The construction section 32 creates the display data of the retrieval result screen containing the combination module name registered in the CM names, the model types of the constituent components constituting the combination module, and various dimensions included in the CAD data, the CM data and the component information of the acquired combination module. Thereafter, the construction section 32 delivers the display data of the created retrieval result screen to the display section 5. The display section 5 displays the display data of the delivered retrieval result screen.

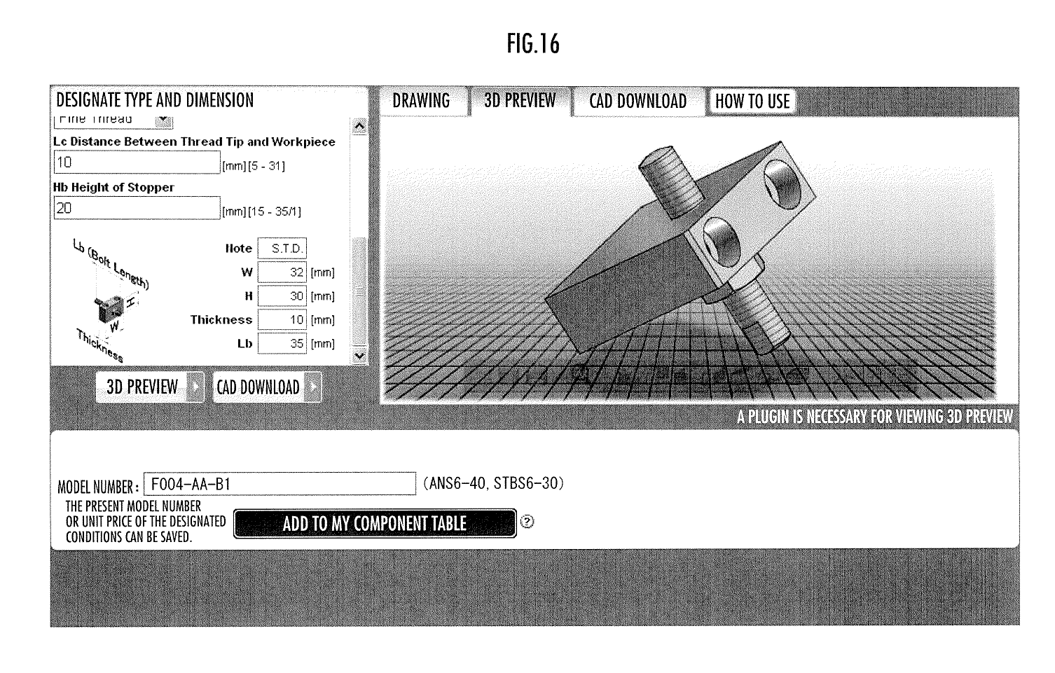

FIG. 16 illustrates one example of the retrieval result screen displayed by the display section 5. In FIG. 16, the values of the design specification input from the user, that is, the values of the design specification of the displayed combination module, the graphics of the combination module on the basis of the 3D CAD data, the CM names (model types) and the model types of the constituent components of the combination module are displayed together with the download button of the CAD data and the like.

When the request for 2D or 3D CAD data is input by the user through the input section 1, the construction section 32 accepts the input, acquires the 2D or 3D CAD data associated with the CM name of the displayed combination module from the graphics DB 23 and outputs it.

Thereafter, with reference to the flow chart of FIG. 17, the operation of the creation-registration process of the combination module “stopper & block” will be described. Note that the component information and the variation maps are preliminarily registered in the component DB 22 and the combination module DB 21.

The administrator inputs through the input section 1 the creation of the combination module. In this embodiment, the sub-module “stopper & block” for the combination module is created; thus, the administrator inputs the sub-module name “stopper & block” through the input section 1.

After accepting the instruction of creating the sub-module name “stopper & block” for the combination module, the constituent component selection section 41 selects a CM type as a processing target (STEP S300). Specifically, the constituent component selection section 41 selects the variation map associated with the sub-module name “stopper & block” from the variation maps registered in the combination module DB 21. The constituent component selection section 41 selects an unprocessed CM type as the processing target from the CM types registered in the CM type names of the selected variation map. In the embodiment, the CM type “F004-AA” registered in the variation map illustrated in the previous FIG. 6 is selected as the processing target.

The constituent component selection section 41 selects block component information as a processing target (STEP S301). Specifically, the constituent component selection section 41 acquires the stopper block types registered in the stopper block type of the constituent component data registered in the variation map associated with the CM type selected as the processing target. Herein, the constituent component selection section 41 acquires the stopper block type “countersunk bore” associated with the CM type “F004-AA”. The constituent component selection section 41 acquires the unprocessed component information from the component information registered in the component DB 22 in association with the acquired stopper block types. In the component information illustrated in the previous FIG. 8, the component information of the model types “STBS6-30”, “STBN6-30” . . . is associated with “countersunk bore” in the stopper block type. Thereby, the constituent component selection section 41 selects the unprocessed component information from the block component information of the model types “STBS6-30”, “STBN6-30” . . . as the processing target. Herein, the constituent component selection section 41 selects the block component information of the model type “STBS6-30” as the processing target.

The constituent component selection section 41 acquires the entire component information of the adjusting screws matching the stopper blocks denoted by the model types of the block component information selected as the processing target from the component information registered in the component DB 22 (STEP S302). Specifically, the constituent component selection section 41 acquires the adjusting screw types of the constituent component data registered in the variation map associated with the CM type selected as the processing target. Herein, the constituent component selection section 41 acquires the adjusting screw type “spanner grooved adjusting screw” associated with the CM type “F004-AA” selected as the processing target. The constituent component selection section 41 acquires, from the adjusting screw component information registered in the component DB 22 associated with the acquired adjusting screw type “spanner grooved adjusting screw”, the entire component information of the adjusting screw which matches the material-surface treatment of the block component information selected as the processing target and satisfies the screw thread degree, the diameter of adjusting screw and the pitch of the block component information selected as the processing target. Note that the matching of the material-surface treatment may be the case where both of the material and the surface treatment are consistent or the case where a matching combination preliminarily input by the administrator through the input section 1 is satisfied.

Herein, the constituent component selection section 41 uses the block component information of the model type “STBS6-30” as the processing target; thereby, acquires the entire component information of “spanner grooved adjusting screw” matching the material-surface treatment “SS40/trivalent chromate treatment”, the screw thread degree “fine thread”, the diameter of adjusting screw “6” and the pitch “0.75”. The constituent component selection section 41 acquires the model types of “ANS6-40” and “ANS6-45” associated with the adjusting screw type “spanner grooved adjusting screw” from the adjusting screw component information illustrated in the previous FIG. 9.

The constituent component selection section 41 selects one piece of unprocessed adjusting screw component information from the acquired adjusting screw component information as a processing target (STEP S303). Herein, the adjusting screw component information of the model type “ANS6-40” is selected as the processing target.

The constituent component selection section 41 delivers the block component information selected as the processing target and the adjusting screw component information selected as the processing target to the dimension calculation section 42. The dimension calculation section 42 calculates each dimension of the combination module on the basis of the delivered block component information selected as the processing target and the delivered adjusting screw component information selected as the processing target.

First, the dimension calculation section 42 calculates the internal design dimension necessary for the combination of the constituent components of the combination module (STEP S304). As illustrated in the previous FIG. 3, the combination module “stopper & block” is constituted by assembling the adjusting screw 71 into the adjusting screw fixing pore disposed in the stopper block 72. Therefore, the internal design dimension of “stopper & block” becomes the length (internal length) of the adjusting screw 71 necessary for assembling the adjusting screw 71 into the adjusting screw fixing pore disposed in the stopper block 72 and fixing it with a nut. The internal length is calculated by the dimension calculation section 42.

The internal length is denoted by Lu, the length of the fastening portion of the adjusting screw (fastening portion length) is denoted by L1, the height of the nut is denoted by Tn, and the thickness of the stopper block is denoted by Tb, the internal length Lu can be obtained according to the following equation 3.

Lu=L1+Tn+Tb (equation 3)

The dimension calculation section 42 calculates the internal length Lu by using the dimensions registered in the adjusting screw component information selected as the processing target and in the block component information selected as the processing target and the above equation 3. The adjusting screw component information selected as the processing target is the component information of the model type “ANS6-40” of the adjusting screw component information illustrated in the previous FIG. 9. The block component information selected as the processing target is the component information of the model type “STBS6-30” of the stopper block component information illustrated in the previous FIG. 8. The dimension calculation section 42 assigns the values of the fastening portion length and the nut height associated with the model type “ANS6-40” and the value of the thickness associated with the model type “STBS6-30” into the equation 3 to calculate out the internal length Lu.

Thereafter, the dimension calculation section 42 calculates the dimension including the essential dimension data of the combination module (STEP S305). The essential dimension data of the combination module “stopper & block” are the clearance Lcb, the screw size Mb and the height of adjusting screw Hb. When the stopper block is determined, the screw size Mb and the height of adjusting screw Hb are determined according to the size of the adjusting screw fixing pore of the stopper block (the screw thread degree, the diameter of adjusting screw, and the pitch), and the fixing height of the adjusting screw; and only the clearance Lcb varies according to the adjusting screw. Thus, the dimension calculation section 42 calculates the clearance Lcb.

First, in order to obtain the clearance Lcb, the dimension calculation section 42 calculates the minimum length for the adjusting screw (adjusting screw minimum length). Herein, the adjusting screw minimum length is denoted by Lmin, the adjusting width of the adjusting screw is denoted by Lab, the adjusting screw minimum length Lmin can be obtained according to the following equation 4.

Lmin=Lu+Lcb+Lab (Equation 4)

Wherein the Lu is the internal length calculated according to the equation 3.

The dimension calculation section 42 sets the clearance Lcb at a predefined nick in a predefined dimension range. For example, the clearance Lcb is set every “1 nick” in the dimension range of “5-30” to have values of 5, 6, 7 . . . 29, and 30.

The adjusting width Lab is a preset value here; however, it may be stored preliminarily in the storage section 2 or may be set by the administrator in creating the combination module through the input section 1. The adjusting width Lab is the width of a play between the adjusting screw fastening portion and the nut. The value of the adjusting width Lab varies according to the clearance Lcb and is determined by design experience. For example, the dimension calculation section 42 sets the value of the adjusting width Lab at ±2 when the clearance Lcb is in the range of 5 to 9; sets the value of the adjusting width Lab at ±3 when the clearance Lcb is in the range of 10 to 15; sets the value of the adjusting width Lab at ±4 when the clearance Lcb is in the range of 16 to 25; and sets the value of the adjusting width Lab at ±5 when the clearance Lcb is greater than 25.

The dimension calculation section 42 uses the internal length Lu calculated according to the abovementioned equation 3 at the previous STEP S304 to calculate the adjusting screw minimum length Lmin for each clearance set at the predefined nick in the predefined dimension range according to the abovementioned equation 4. The dimension calculation section 42 stores the calculated adjusting screw minimum length Lmin for each clearance Lcb in association with the clearance Lcb (STEP S306).

The dimension calculation section 42 acquires the entire adjusting screw component information having the same values of the nut height and the fastening portion as the adjusting screw component information selected as the processing target from the adjusting screw component information matching the stopper block of the block component information selected as the processing target acquired at STEP S302 (STEP S307). As aforementioned, the stopper block component information selected as the block component information selected as the processing target is the component information of the model type “STBS6-30” in which the thickness Tb of the stopper block is constant. Thereby, when adjusting screws having the fastening portion length and the nut height equal to those of the adjusting screw component information selected as the processing target are used, the internal lengths Lu obtained from the abovementioned equation 3 are all equal. In other words, the dimension calculation section 42 acquires the entire adjusting screw component information in which the stopper blocks denoted by the block component information selected as the processing target match the adjusting screws denoted by the adjusting screw component information selected as the processing target and the adjusting screws having the equal internal length Lu to the adjusting screws denoted by the adjusting screw component information selected as the processing target. In the acquired adjusting screw component information, the material-surface treatment, the diameter of adjusting screw, the pitch, the screw thread degree, the nut height and the fastening portion length are the same, only the length is different. In the adjusting screw component information illustrated in the previous FIG. 9, the adjusting screw component information associated with the model type “ANS6-40” belongs to the adjusting screw component information selected as the processing target. The adjusting screw component information associated with the model type “ANS6-45” having the material-surface treatment, the diameter of adjusting screw, the pitch, the screw thread degree, the nut height and the fastening portion length consistent with those of the adjusting screw component information associated with the model type “ANS6-40” is acquired.

The dimension calculation section 42 selects the adjusting screw component information having the length adequate to the clearance from the acquired adjusting screw component information (STEP S308). Specifically, the dimension calculation section 42 determines that the length of the adjusting screw component information (length of the adjusting screw) is adequate to the clearance if the length of the adjusting screw is equal to or greater than the adjusting screw minimum length Lmin for each clearance Lcb stored in memory and is closest to the adjusting screw minimum length Lmin, and selects the adjusting screw component information having the adequate length. In more details, the thickness of the stopper block for the model type “STBS6-30” is 22, the fastening portion length and the nut height for the model type “ANS6-40” and for the model type “ANS6-45” are equal to 5 and 4, respectively. Thus, according to the above equation 3, the internal length Lu is 31. Moreover, according to the above equation 4, when the clearance Lcb is from 5 to 7, the adjusting screw minimum length Lmin is from 38 to 40; and when the clearance Lcb is from 8 to 12, the adjusting screw minimum length Lmin is from 41 to 45. Thereby, the dimension calculation section 42 selects the adjusting screw having the length equal to 40 (in the present case, the adjusting screw component information of the model type “ANS6-40”) if the clearance Lcb is from 5 to 7, and selects the adjusting screw having the length equal to 45 (in the present case, the adjusting screw component information of the model type “ANS6-45”) if the clearance Lcb is from 8 to 12.

The dimension calculation section 42 creates the CM information on the basis of the adjusting screw component information and the block component information selected as the processing target selected at every clearance Lcb and registers the created CM information in the combination module DB 21 (STEP S309). Specifically, as described with reference to the previous FIG. 7, the registration items of the CM information for the combination module “stopper & block” include the CM type name, the CM name and the CM data. The dimension calculation section 42 registers the CM type of the processing target in the CM type name and the CM name thereof in the CM name. The CM name may be automatically created by the dimension calculation section 42 by appending a serial number or a unique identifier to the CM type.

The registration items of the CM data include the adjusting screw data having the model type, the material-surface treatment, the screw thread degree, the diameter of adjusting screw, the pitch, the clearance, the adjusting width and the length as the registration items; and the stopper block data having the model type, the material-surface treatment, the screw thread degree, the diameter, the pitch and the height as the registration items. The dimension calculation section 42 registers the model type, the material-surface treatment, the screw thread degree, the diameter of adjusting screw, the pitch, and the length of the adjusting screw component information selected in the model type, the material-surface treatment, the screw thread degree, the diameter of adjusting screw, the pitch, and the length of the adjusting screw data; registers the value of the clearance corresponding to the adjusting screw in the clearance of the adjusting screw data; and registers the adjusting width set according to the clearance in the adjusting width of the adjusting screw data. Moreover, the dimension calculation section 42 registers the model type, the material-surface treatment, the screw thread degree, the diameter, and the adjusting screw fixing height of the block component information selected as the processing target in the model type, the material-surface treatment, the screw thread degree, the diameter, the pitch and the adjusting screw fixing height of the stopper block data.

After the dimension calculation section 42 has registered the CM information in the combination module DB 21, the constituent component selection section 41 determines whether or not the unprocessed adjusting screw component information is present in the adjusting screw component information (the adjusting screw information matching the stopper block denoted by the model type of the block component information selected as the processing target) acquired at the previous STEP S302 (STEP S310). Note that the constituent component selection section 41 determines the adjusting screw component information acquired at the previous STEP S307 having the nut height and the fastening portion length consistent with those of the adjusting screw component information selected as the processing target as the processed one.

When it is determined that the unprocessed adjusting screw component information is present (Yes at STEP S310), the constituent component selection section 41 selects one of the unprocessed adjusting screw component information as the processing target; the dimension calculation section 42, on the basis of the block component information selected as the processing target and the adjusting screw component information selected as the processing target, repeats the process of calculating the dimensions of the combination module and registering the CM information in the combination module DB 21 until there is no unprocessed adjusting screw component information existing (STEP S303 to S310).

When it is determined that the unprocessed adjusting screw component information is not present (No at STEP S311), the constituent component selection section 41 determines whether or not the unprocessed block component information is present in the stopper block component information associated with the stopper block types registered in the stopper block type of the constituent component data registered in the variation map associated with the CM type selected as the processing target selected at the previous STEP S300 from the component information registered in the component DB 22 (STEP S311).

When it is determined that the unprocessed stopper block component information is present (Yes at STEP S310), the constituent component selection section 41 selects one of the unprocessed stopper block component information as a new processing target, acquires the entire adjusting screw component information consistent with the stopper blocks denoted by the model types of the block component information selected as the processing target and selects the adjusting screw component information selected as the processing target; and the dimension calculation section 42, on the basis of the block component information selected as the processing target and the adjusting screw component information selected as the processing target, repeats the process of calculating the dimensions of the combination module and registering the CM information in the combination module DB 21 until there is no unprocessed stopper block component information existing (STEP S301 to S311).

When it is determined that the unprocessed stopper block component information is not present (No at STEP S311), the constituent component selection section 41 determines whether or not the unprocessed CM types are present in the CM types of the variation maps registered in the combination module DB 21 associated with the input sub-module name (STEP S312).

When it is determined that the unprocessed CM types are present (Yes at STEP S312), the constituent component selection section 41 selects one of the unprocessed CM types as a new processing target, selects one of the stopper block component information registered in the component DB 22 associated with the CM type selected as the processing target as a new processing target, acquires the entire adjusting screw component information satisfying the stopper blocks denoted by the model types of the block component information selected as the processing target and selects the adjusting screw component information selected as the processing target; the dimension calculation section 42, on the basis of the block component information selected as the processing target and the adjusting screw component information selected as the processing target, repeats the process of calculating the dimensions of the combination module and registering the CM information in the combination module DB 21 until there is no unprocessed stopper block component information existing (STEP S300 to S311).

When it is determined that the unprocessed CM type is not present (No at STEP S312), the constituent component selection section 41 terminates the creation-registration process of the combination module.

As described above in the first embodiment, the storage section preliminarily stores the combination module DB 21 in which the CM type which is the assembly example data pertaining to the assembly example of a plurality of combination modules, the variation map in which the constituent component data pertaining to combinations of the constituent components in the assembly examples is registered in associated with the CM type, and the CM information in which the assembly dimension data of the combination modules is registered in association with the CM type; the retrieval section 31 retrieves the combination module having the essential dimension data minimum required in the design process as the input combination module from the CM information registered in the combination module DB 21 in association with the input CM type; the construction section 32 constructs the data including the identifiers of the constituent components of the combination module retrieved by the retrieval section 31; and the display section 5 displays the display data of the combination module constructed by the construction section 32.

In other words, the design dimension of the combination module contains two kinds of dimension data: the essential dimension data determining the design specification of the combination module required by the user and the internal design dimension determined by the dimensions of the constituent components of the combination module without depending on the essential dimension data. Based on this point, the internal dimension of the combinable constituent components is calculated; the CM information containing the calculated internal dimension and the essential dimension data calculated from the dimensions of the constituent components, and the constituent component data pertaining to the combinations of the constituent components are preliminarily registered in the combination module DB 21 in association with the CM types pertaining to the assembly examples of the combination module. That is to say, the constituent components are preliminarily selected and the combination modules corresponding to various essential dimension data are prepared preliminarily. When the essential dimension data is input by the user, the combination module satisfying the input essential dimension data is selected from the prepared combination modules to be provided to the user.

Thereby, the combination module desired by the user can be provided only with the essential dimension data minimum required in the design process for the combination module obtained by combining a plurality of components, which contributes to shortening the design time.

In the first embodiment, the components constituting the combination module are standard components, and the input section 1 is configured to allow the user to select the input data consistent with the standard components. Thereby, the instance where there is no combination module satisfying the input conditions (no hits) can be avoided, the combination module satisfying the input data can be provided with the input of one time instead of being input twice, which contributes to shortening the design time.

In the first embodiment, the storage section 2 is configured to further store the component DB 22 registered with the component information pertaining to at least the dimensions and the materials of the components; the constituent component selection section 41 is configured to select the components satisfying the combination conditions of the constituent components given by the constituent component data registered in the combination module DB 21 from the data registered in the component DB 22; the dimension calculation section 42 is configured to calculate the essential dimension data on the basis of the dimensions of the components selected by the constituent component selection section 41 for a combination module specified according to the selected components so as to create the CM information and register the created CM information in the combination module DB 21.

Thus, by registering only the CM type, the constituent component data and the component DB 22, it is possible to create the combination module and it is also possible to save time in creating the combination module in consideration of the combinations of the components. Moreover, even a new component is added, by registering incrementally the added component into the component DB 22, it is possible to create the combination module with the component as one of the constituent components in a short time.

In the first embodiment, the construction section 32 is configured to create the display data of the retrieval result screen which is the combination module data containing the identifiers (the model numbers) for identifying the constituent components of the combination module and the display section 5 is configured to display the display data of the retrieval result screen. Thereby, the use can recognize the constituent components of the combination module.

Further in the first embodiment, the construction section 32 is configured to include the CAD data of the combination module registered in the graphics DB 23 in creating the display data of the retrieval result screen and the display section 5 is configured to display the display data of the retrieval result screen. Thereby, since the use can acquire the CAD data of the combination module, it is not necessary to acquire the CAD data of the constituent components piece by piece and assemble them into the assembly drawing, which contributes to improving the design efficiency.

### Second Embodiment

In the first embodiment described previously, the operation of the apparatus for providing combination module is explained with a combination module of the sub-module “stopper & block” as an example. However, as illustrated by the previous FIG. 5, the functions of the combination module provided by the apparatus for providing combination module are not limited to “stopper & block”. If the function of the combination module becomes different, the constituent components will be different, and consequently, it will lead to different essential dimension data and internal design dimension. Thus, the combination module selection process and the combination module creation-registration process will become different according to individual function of the combination module. In the second embodiment, the descriptions will be performed on the combination module selection process and the combination module creation-registration process for a combination module belonging to a sub-module “sensor stand”.

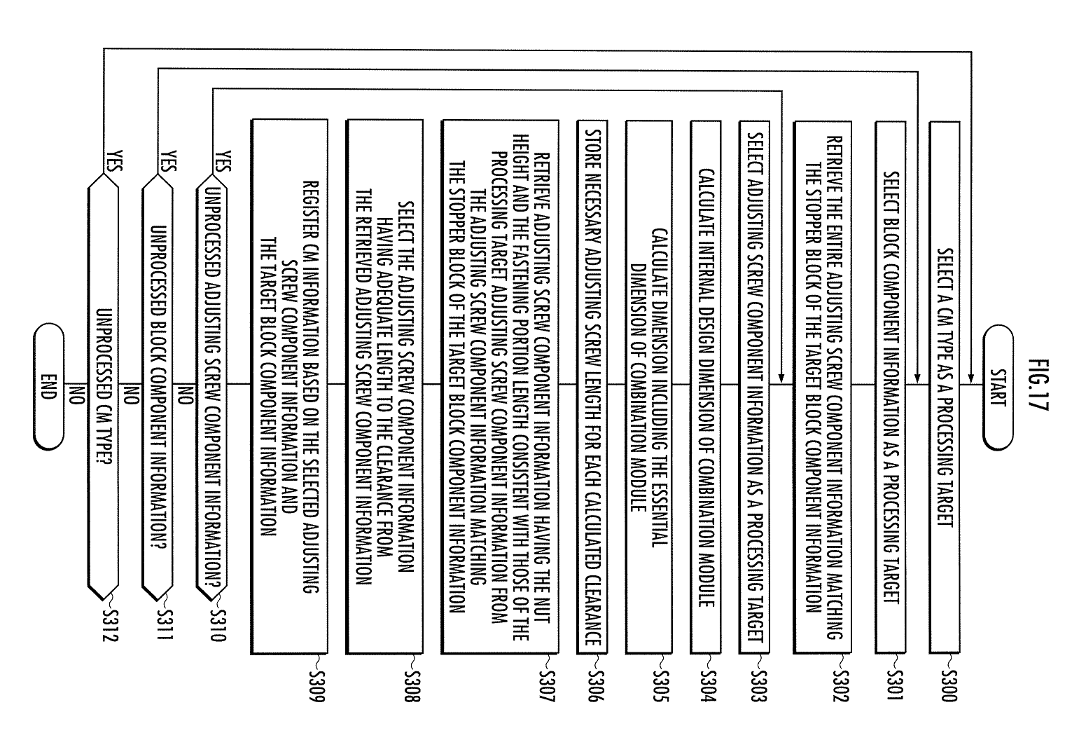

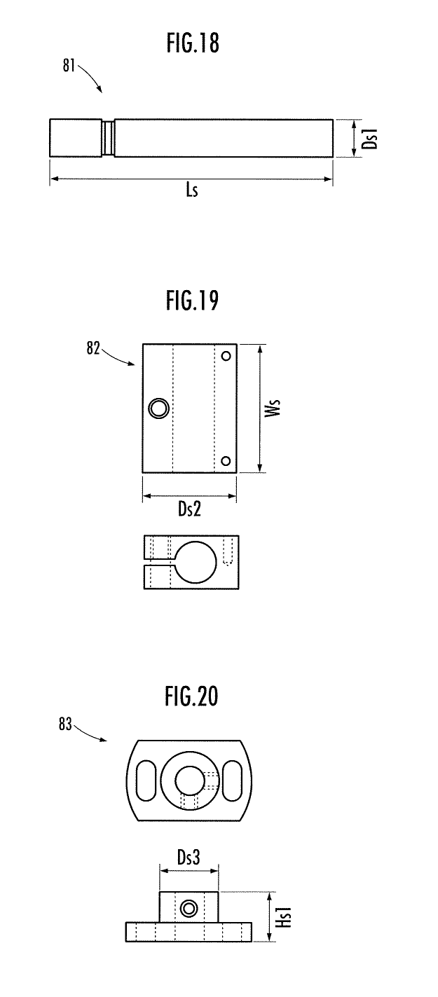

Firstly, the combination module belonging to the sub-module “sensor stand” according to the second embodiment will be explained with reference to FIG. 18 through FIG. 21. The sub-module “sensor stand” is composed of a supporting column 81 illustrated in FIG. 18, a supporting column clamp illustrated in FIG. 19, and a supporting column stand illustrated in FIG. 20 as the constituent components.

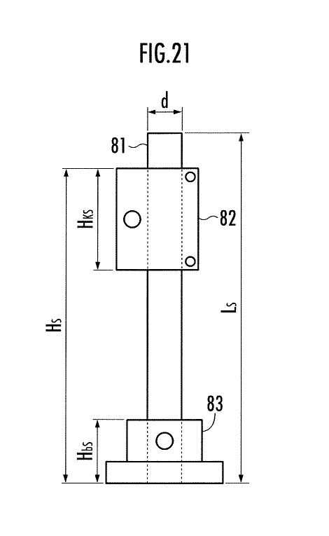

FIG. 21 illustrates the configuration of the sub-module “sensor stand”. In FIG. 21, the sub-module “sensor stand” has the supporting column 81 illustrated in the previous FIG. 18 assembled into the supporting column fixing pore disposed in the supporting column stand 83 illustrated in the previous FIG. 20 and the supporting column clamp 82 illustrated in the previous FIG. 19 mounted on the supporting column 81 to realize the function of setting a sensor at a predefined position. The essential dimension data of the sub-module “sensor stand” includes the supporting column length Ls of the supporting column 81, the supporting column diameter d of the supporting column 81, and the height (sensor height) Hs from the installation surface of the sub-module “sensor stand” to the sensor.

The configuration of the apparatus for providing combination module of the second embodiment is identical to that of the apparatus for providing combination module of the first embodiment described previously; however, the variation maps and the CM information registered in the combination module DB 21, the component information registered in the component DB 22, and the processes performed by the selection section 3 and the creation section 4 are different.

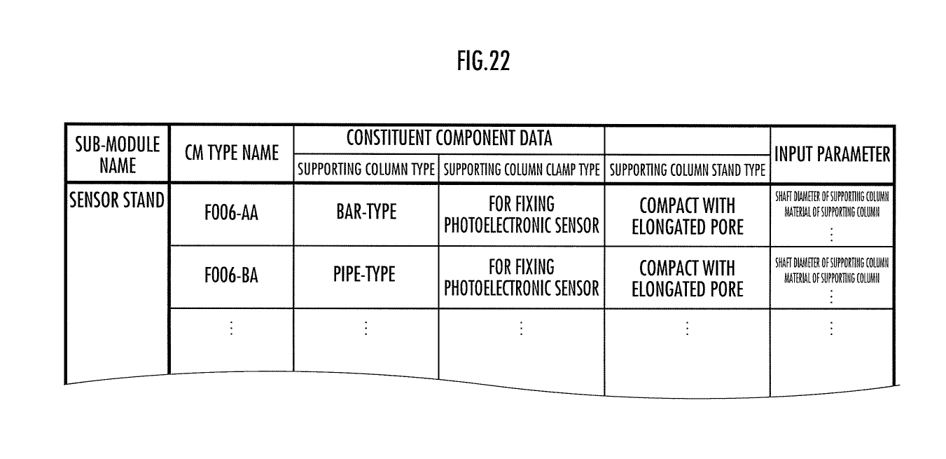

FIG. 22 illustrates one example of the variation map associated with the sub-module “sensor stand”. In the variation map associated with the sub-module “sensor stand” illustrated in FIG. 22, similar to the variation map associated with the sub-module “stopper & block” illustrated in the previous FIG. 6, the sub-module name, the CM type name registered with the identifier for identifying the CM type, the constituent component data pertaining to the combination of components for the CM type, and the input parameters registered with items of various data for the design specification to request the user are registered as the registration items of the variation map; however, the constituent component data of the variation map associated with the sub-module “sensor stand” has the registration items different from that of the variation map associated with the sub-module “stopper & block”.

In FIG. 22, the supporting column type registered with shapes of the supporting columns serving as the constituent components of the sub-module “sensor stand”, the supporting column clamp type registered with the features of the supporting column clamp, and the supporting column stand type registered with a shape of the supporting column stand are registered as the registration items of the constituent component data. In other words, since the constituent components are different for each sub-module, the constituent component data of the variation map will have the registration items registered with the constituent components of different shapes and features for each sub-module.

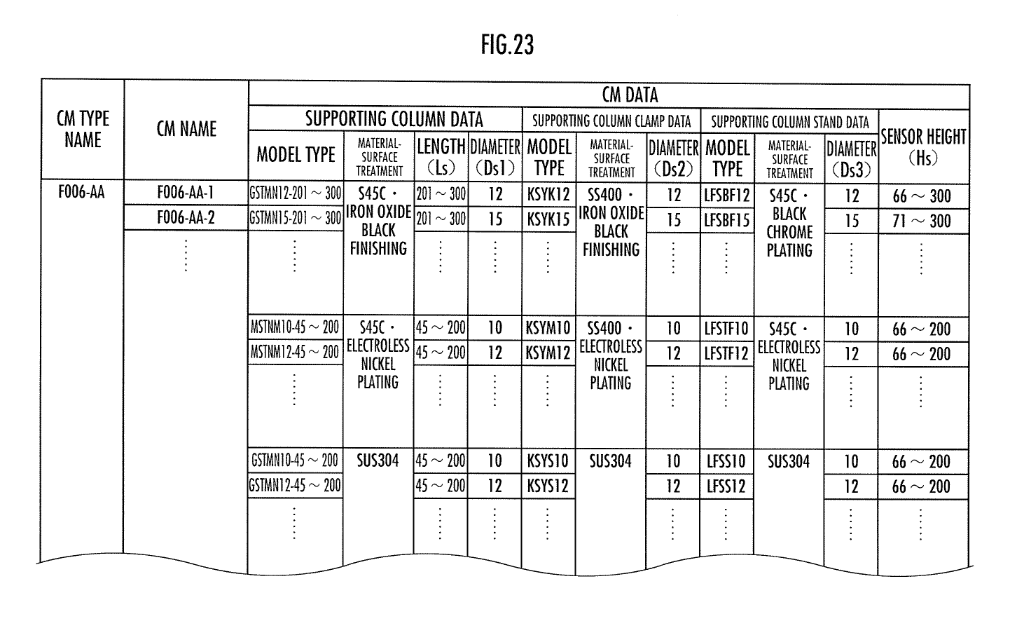

FIG. 23 illustrates one example of the CM information associated with the combination module type “F006-AA” of the variation map associated with the sub-module “sensor stand” illustrated in the previous FIG. 22. In FIG. 23, the CM type name registered with the CM types, the CM name registered with the identifiers for identifying the combination module belonging to the CM type, and the CM data registered with information pertaining to the combination modules registered in the CM name are registered as the registration items of the CM information. As the registration items of the CM data, the supporting column data, the supporting column clamp data, the supporting column stand data, and the sensor height of the constituent components of the combination module are registered.

The model type, the material-surface treatment, the length and the diameter are registered as the registration items of the supporting column data. In the model type, the identifiers (model types) for identifying the components of the supporting column are registered. In the material-surface treatment, the material and the surface treatment of the supporting column registered in the model type are registered. The length of the supporting column registered in the model type is registered in the length. The shaft diameter of the supporting column registered in the model type is registered in the diameter.

The model type, the material-surface treatment, and the diameter are registered as the registration items of the supporting column clamp data. The identifiers (model type) for identifying the components of the supporting column clamp are registered in the model type. In the material-surface treatment, the material and the surface treatment of the supporting column clamp registered in the model type are registered. The diameter of a fixing pore for fixing the supporting column clamp to the supporting column is registered in the diameter.

The model type, the material-surface treatment, and the diameter are registered as the registration items of the supporting column stand data. The identifiers (model type) for identifying the components of the supporting column stand are registered in the model type. In the material-surface treatment, the material and the surface treatment of the supporting column stand registered in the model type are registered. The diameter of a fixing pore for fixing the supporting column is registered in the diameter.

The sensor position is registered with the height of the sensor (sensor position) of the sensor stand obtained by combining the components registered in the model type of the supporting column information, the supporting column clamp information and the supporting column stand information. In the CM information illustrated in FIG. 23, the length in the supporting column data, the diameter in the supporting column data and the sensor height are the essential dimension data.

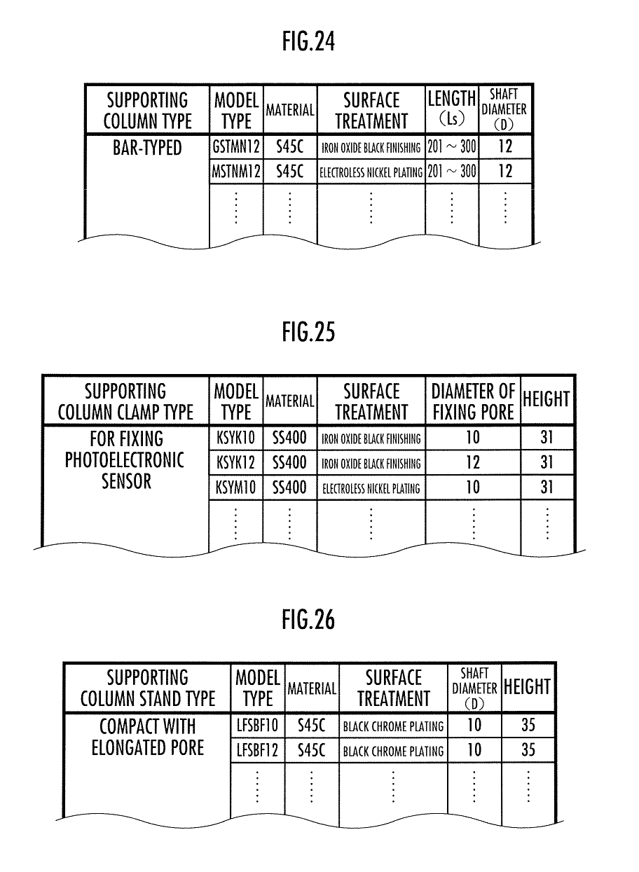

FIG. 24 to FIG. 26 illustrate examples of the component information of the constituent components for the sub-module “sensor stand”. FIG. 24 illustrates one example of the component information associated with the supporting column type. In

FIG. 24, the model type, the material, the surface treatment, the length and the shaft diameter are registered as the registration items of the component information associated with “supporting column type”.

The supporting column type is registered with the supporting column types of the constituent component data for the sub-module “sensor stand” illustrated in the previous FIG. 22. The model type is registered with identifiers (model types) for identifying the components of different shapes of the supporting columns registered in the support column type. The material is registered with the materials of the components registered in the model type. The surface treatment is registered with the surface treatments for the components registered in the model type. The length is registered with the lengths of the components registered in the model type. The shaft diameter is registered with the shaft diameters of the components registered in the model type.

FIG. 25 illustrates one example of the component information associated with the supporting column clamp. In FIG. 25, the model type, the material, the surface treatment, the fixing pore diameter, and the height are registered as the registration items of the component information associated with “supporting column clamp type”.

The supporting column clamp type is registered with the supporting column clamp type of the constituent component data of the sub-module “sensor stand” illustrated in the previous FIG. 22. The model type is registered with identifiers (model types) for identifying the components of different shapes of the supporting column clamp types registered in the support column clamp type. The material is registered with the materials of the components registered in the model type. The surface treatment is registered with the surface treatments for the components registered in the model type. The fixing pore diameter is registered with the diameters of the fixing pores for the components registered in the model type. The height is registered with the heights of the components registered in the model type.

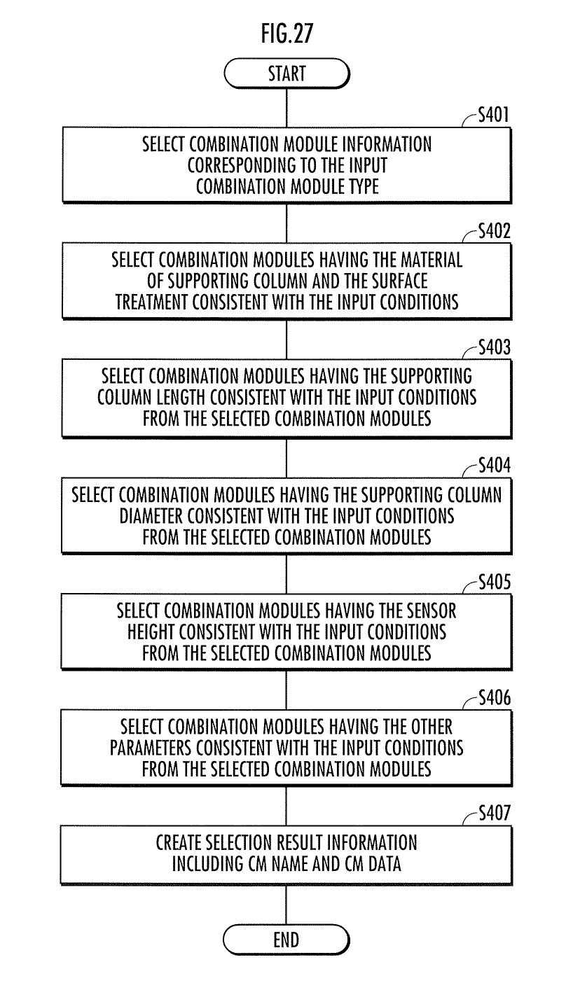

FIG. 26 illustrates one example of the component information associated with the supporting column stand. In FIG. 26, as the registration items of the component information associated with “supporting column stand”, the model type, the material, the surface treatment, the shaft diameter, and the height are registered.

The supporting column stand type is registered with the supporting column stand type of the constituent component data of the sub-module “sensor stand” illustrated in the previous FIG. 22. The model type is registered with identifiers (model types) for identifying the components of different shapes of the supporting column stand types registered in the support column stand type. The material is registered with the materials of the components registered in the model type. The surface treatment is registered with the surface treatments for the components registered in the model type. The shaft diameter is registered with the diameters of the fixing pores for the components registered in the model type. The height is registered with the heights of the components registered in the model type.

The registration items of the component information illustrated in FIG. 24 to FIG. 26 mention only the necessary items for describing the operations of the apparatus for providing combination module of the second embodiment; thereby, in actual use, it is acceptable to include the entire information in the written standard table of the catalog as the registration items.

Hereinafter, the operations of the combination module selecting process of the sub-module “sensor stand” will be described. The combination module selecting process of the sub-module “sensor stand” is similar to the combination module selecting process of the “stopper & block” described previously in the first embodiment with reference to the flow chart in FIG. 15 except that the retrieval process of STEP S104 is different; thereby, only the retrieval process of the combination module of the sub-module “sensor stand” will be described here with reference to the flow chart of FIG. 27. Moreover, for the same operations as the retrieval process of the “stopper & block” described with reference to the flow chart of the previous FIG. 15, the detailed description thereof will be omitted.

The retrieval section 31 selects the CM information corresponding to the input CM type input by the user through the variation selecting screen from the CM information registered in the combination module DB 21 (STEP S401). The retrieval section 31 selects the entire combination modules having the material-surface treatment of the supporting column consistent with the input conditions from the acquired CM information (STEP S402).

The retrieval section 31 selects the entire combination modules having the material-surface treatment of the supporting column consistent with the input conditions from the selected combination modules (STEP S203). The retrieval section 31 selects the combination modules having the length of the supporting column consistent with the input conditions from the selected combination modules (STEP S403). The retrieval section 31 selects the combination modules having the diameter of the supporting column consistent with the input conditions from the selected combination modules (STEP S404). The retrieval section 31 selects the combination modules having the sensor height satisfying the input conditions from the selected combination modules (STEP S405). The retrieval section 31 selects the combination modules consistent with the other input conditions from the selected combination modules (STEP S406).

After the combination module satisfying the entire conditions is selected, the retrieval section 31 acquires the CM name of the selected combination module and the CM data associated with the combination module registered in the CM name, and creates the selection result information including the CM name and the acquired CM data (STEP S407). The retrieval process is terminated after the retrieval section 31 delivers the created selection result information to the construction section 32.

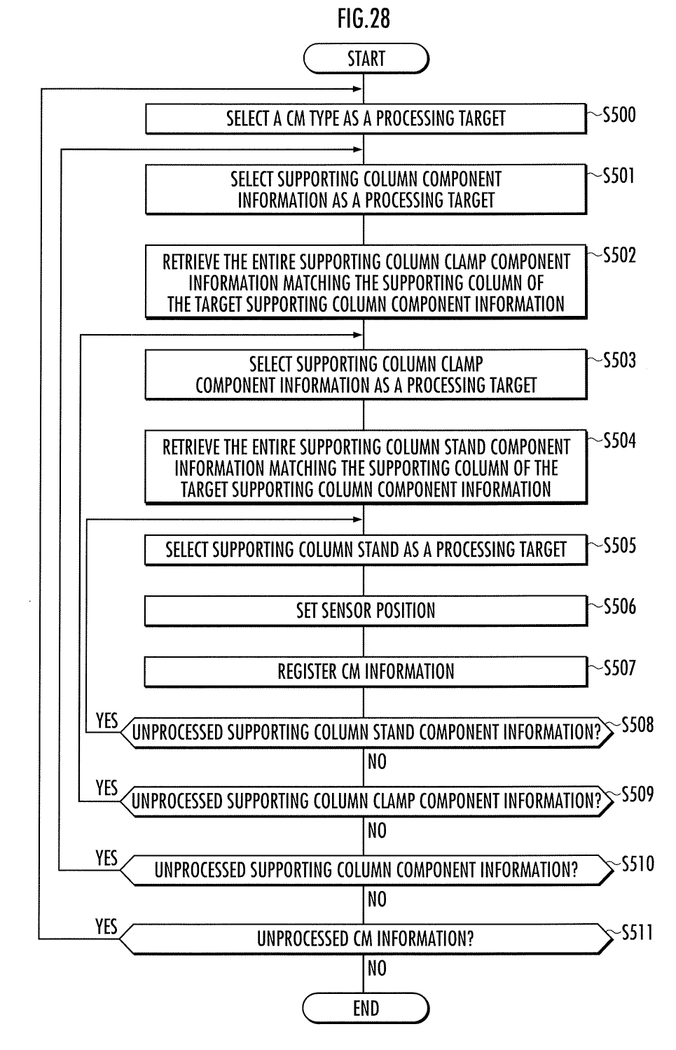

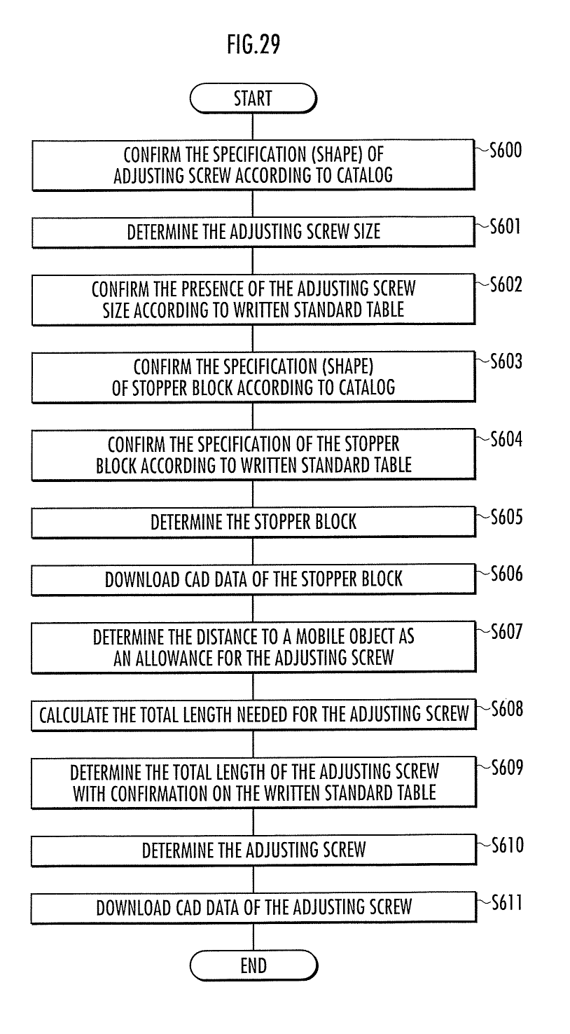

Hereinafter, the operations of the creation-registration process of the combination module “sensor stand” will be described with reference to the flow chart in FIG. 28. The administrator inputs the creation of the combination module through the input section 1. Herein, the combination module to be created is the sub-module “sensor stand”, the administrator inputs the sub-module name “sensor stand” through the input section 1.

After accepting the instruction of creating the combination module of the sub-module name “sensor stand”, the constituent component selection section 41 selects a CM type as a processing target (STEP S500). Specifically, the constituent component selection section 41 selects the variation map associated with the sub-module name “sensor stand” from the variation maps registered in the combination module DB 21. The constituent component selection section 41 selects an unprocessed CM type from the CM types registered in the CM type name of the selected variation map as the CM type selected as the processing target. In the embodiment, the CM type “F006-AA” registered in the variation map illustrated in the previous FIG. 22 is selected as the processing target.

The constituent component selection section 41 selects the supporting column component information as a processing target (STEP S501). Specifically, the constituent component selection section 41 acquires the supporting column types registered in the supporting column type of the constituent component data registered in the variation map associated with the CM type selected as the processing target. Herein, the constituent component selection section 41 acquires the supporting column type “bar-type” associated with the CM type “F006-AA”. The constituent component selection section 41 acquires the unprocessed component information from the component information registered in the component DB 22 in association with the acquired supporting column types. In the component information illustrated in the previous FIG. 24, the component information of the model types of “GSTMN10”, “MSTNM10” . . . is associated with the supporting column type “bar-type”. Thereby, the constituent component selection section 41 selects the unprocessed component information from the component information of the model types of “GSTMN10”, “MSTNM10” . . . as the block component information selected as the processing target. Herein, the constituent component selection section 41 selects the supporting column component information of the model type “GSTMN10” as the processing target.

The constituent component selection section 41 acquires the entire component information of the supporting column clamps matching the supporting columns denoted by the model types of the supporting column component information selected as the processing target from the component information registered in the component DB 22 (STEP S502). Specifically, the constituent component selection section 41 acquires the supporting column clamp types of the constituent component data registered in the variation map associated with the CM type selected as the processing target and acquires the supporting column clamp component information registered in the component DB 22 in association with the acquired supporting column clamp types. The constituent component selection section 41 acquires the entire component information of the supporting column clamp having the material-surface treatment of the supporting column component information selected as the processing target matching the material-surface treatment of the acquired supporting column clamp component information and having the shaft diameter of the supporting column component information selected as the processing target consistent with the fixing pore diameter of the supporting column clamp component information. Note that the matching of the material-surface treatment may be the case where both of the material and the surface treatment are consistent or the case where a matching combination preliminarily input by the administrator through the input section 1 is satisfied.

The constituent component selection section 41 selects one piece of unprocessed component information from the acquired supporting column clamp component information as the supporting column clamp component information selected as a processing target (STEP S503). The constituent component selection section 41 acquires the entire component information of the supporting column stands matching the supporting columns denoted by the model types of the supporting column component information selected as the processing target from the component information registered in the component DB 22 (STEP S504). Specifically, the constituent component selection section 41 acquires the supporting column stand types of the constituent component data registered in the variation map associated with the CM type selected as the processing target and acquires the supporting column stand component information registered in the component DB 22 in association with the acquired supporting column stand types. The constituent component selection section 41 acquires the entire component information of the supporting column stands having the material-surface treatment of the supporting column component information selected as the processing target matching the material-surface treatment of the acquired supporting column clamp component information and having the shaft diameter of the supporting column component information selected as the processing target consistent with the shaft diameter of the acquired supporting column stand component information. Note that the matching of the material-surface treatment may be the case where both of the material and the surface treatment are consistent or the case where a matching combination preliminarily input by the administrator through the input section 1 is satisfied.

The constituent component selection section 41 selects one piece of unprocessed supporting column stand component information from the acquired supporting column stand component information as a processing target (STEP S505). The constituent component selection section 41 delivers the supporting column component information selected as the processing target, the supporting column clamp component information selected as the processing target and the supporting column stand component information selected as the processing target to the dimension calculation section 42. The dimension calculation section 42 calculates each dimension of the combination module on the basis of the delivered the supporting column component information selected as the processing target, the delivered supporting column clamp component information selected as the processing target and the delivered supporting column stand component information selected as the processing target.

The dimension calculation section 42 sets the sensor height (STEP S506). As illustrated in the previous FIG. 21, the combination module “sensor stand” is composed of the supporting column 82 disposed in the supporting column stand 83 and the supporting column clamp disposed on the supporting column 81. The supporting column clamp can be set at a predefined nick in the length range of the supporting column. Herein, the setting position of the supporting column clamp 82 in the factory setting is set as the sensor height Hs at a possible nick of 1 mm. If the height of the supporting column stand is set as Hbs and the height of the supporting column clamp is set as Hks, then, the minimum value Hs (min) of the sensor height will be “Hbs+Hks” and the maximum value Hs (max) of the sensor height will be “Ls”. Thereby, the setting range of the sensor height Hs will be “Hbs≦Hs≦Ls”. The dimension calculation section 42 calculates the minimum value Hs (min) and the maximum value Hs (max) of the sensor height according to the length of the processing target supporting column, the height of the supporting column clamp selected as the processing target and the height of the supporting column stand selected as the processing target so as to calculate the setting range of the sensor height Hs.

The dimension calculation section 42 creates the CM information on the basis of the calculated setting range of the sensor height Hs, the supporting column component information selected as the processing target, the supporting column clamp component information selected as the processing target and the supporting column stand component information selected as the processing target and registers the created CM information in the combination module DB 21 (STEP S507). Specifically, as described by using the previous FIG. 23, the registration items of the CM information for the combination module “sensor stand” includes the CM type, the CM name and the CM data. The dimension calculation section 42 registers the CM type of the processing target in the CM type and the CM name thereof in the CM name. The CM name may be automatically generated by the dimension calculation section 42 by appending a serial number or a unique identifier to the CM type.

The registration items of the CM data includes the supporting column data having the model type, the material-surface treatment, the length and the diameter as its registration items; the supporting column clamp data having the model type, the material-surface treatment and the diameter as its registration items; the supporting column stand data having the model type, the material-surface treatment and the diameter as its registration items; and the sensor height. The dimension calculation section 42 registers the model type, the material-surface treatment, the length and the shaft diameter of the supporting column component data selected as the processing target in the model type, the material-surface treatment, the length and the diameter of the supporting column data; registers the model type, the material-surface treatment and the fixing pore diameter of the supporting column clamp component information selected as the processing target in the model type, the material-surface treatment and the diameter of the supporting column clamp data; registers the model type, the material-surface treatment and the shaft diameter of the supporting column stand component data selected as the processing target in the model type, the material-surface treatment and the diameter of the supporting column stand data; and registers the setting range of the sensor height obtained at STEP S506 in the sensor height.

After the dimension calculation section 42 has registered the CM information in the combination module DB 21, the constituent component selection section 41 determines whether or not the unprocessed supporting column stand component information is present in the supporting column stand component information acquired at the previous STEP S504 (STEP S508).

When it is determined that the unprocessed supporting column stand component information is present (Yes at STEP S508), the constituent component selection section 41 selects one of the unprocessed supporting column stand component information as a processing target; and the dimension calculation section 42, on the basis of the supporting column component information selected as the processing target, the supporting column clamp component information selected as the processing target and the supporting column stand component information selected as the processing target, repeats the process of calculating each dimension (herein, the setting range of the sensor height) of the combination module and registering the CM information in the combination module DB 21 until there is no unprocessed supporting column stand component information existing (STEP S505 to S508).

When it is determined that the unprocessed supporting column stand component information is not present (No at STEP S508), the constituent component selection section 41 determines whether or not the unprocessed supporting column clamp component information is present in the supporting column clamp component information acquired at the previous STEP S502 (STEP S509).

When it is determined that the unprocessed supporting column clamp component information is present (Yes at STEP S509), the constituent component selection section 41 selects one of the unprocessed supporting column clamp component information as a new processing target, acquires the entire supporting column stand component information consistent with the supporting columns of the supporting column component information selected as the processing target and selects the supporting column stand component information selected as the processing target; and the dimension calculation section 42, on the basis of the supporting column component information selected as the processing target, the supporting column clamp component information selected as the processing target and the supporting column stand component information selected as the processing target, repeats the process of calculating each dimension (herein, the setting range of the sensor height) of the combination module and registering the CM information in the combination module DB 21 until there is no unprocessed supporting column clamp component information existing (STEP S503 to S509).

When it is determined that the unprocessed supporting column clamp component information is not present (No at STEP S509), the constituent component selection section 41 determines whether or not the unprocessed supporting column component information is present in the supporting column component information associated with the supporting column types registered in the supporting column type of the constituent component data registered in the variation map associated with the CM type selected as the processing targets selected at the previous STEP S500 from the component information registered in the component DB 22 (STEP S510).

When it is determined that the unprocessed supporting column component information is present (Yes at STEP S510), the constituent component selection section 41 selects one of the unprocessed supporting column component information as a new processing target, acquires the entire supporting column clamp component information consistent with the supporting columns denoted by the model types of the supporting column component information selected as the processing target and selects the supporting column clamp component information selected as the processing target, and acquires the entire supporting column stand component information consistent with the supporting columns of the supporting column component information selected as the processing target and selects the supporting column stand component information selected as the processing target; and the dimension calculation section 42, on the basis of the supporting column component information selected as the processing target, the supporting column clamp component information selected as the processing target and the supporting column stand component information selected as the processing target, repeats the process of calculating each dimension (herein, the setting range of the sensor height) of the combination module and registering the CM information in the combination module DB 21 until there is no unprocessed supporting column component information existing (STEP S501 to S510).

When it is determined that the unprocessed supporting column component information is not present (No at STEP S510), the constituent component selection section 41 determines whether or not unprocessed CM type is present in the CM type of the variation map registered in the combination module DB 21 in association with the input sub-module name (STEP S511).

When it is determined that the unprocessed CM type is present (Yes at STEP S511), the constituent component selection section 41 selects one of the unprocessed CM types as a new processing target and selects one of the supporting column component information registered in the component DB 22 in association with the CM type selected as the processing target as a new processing target, acquires the entire supporting column clamp component information consistent with the supporting columns denoted by the model types of the supporting column component information selected as the processing target and selects the supporting column clamp component information selected as the processing target, and acquires the entire supporting column stand component information consistent with the supporting columns of the supporting column component information selected as the processing target and selects the supporting column stand component information selected as the processing target; and the dimension calculation section 42, on the basis of the supporting column component information selected as the processing target, the supporting column clamp component information selected as the processing target and the supporting column stand component information selected as the processing target, repeats the process of calculating each dimension (herein, the setting range of the sensor height) of the combination module and registering the CM information in the combination module DB 21 until there is no unprocessed CM type existing (STEP S500 to S511).

When it is determined that the unprocessed CM type is not present (No at STEP S511), the constituent component selection section 41 terminates the creation-registration process of the combination module.

As described above in the second embodiment, the storage section preliminarily stores the combination module DB 21 in which the CM type which is the assembly example data is registered pertaining to the assembly example of a plurality of combination modules, the variation map in which the constituent component data pertaining to combinations of the constituent components in the assembly examples is registered in associated with the CM type, and the CM information in which the assembly dimension data of the combination modules is registered in association with the CM type; the retrieval section 31 retrieves the combination module having the essential dimension data minimum required in the design process as the input combination module from the CM information registered in the combination module DB 21 in association with the input CM type; the construction section 32 constructs the data including the identifiers of the constituent components of the combination module retrieved by the retrieval section 31; and the display section 5 displays the data of the combination module constructed by the construction section 32.

Thereby, the desired combination module by the user can be provided only with the essential dimension data minimum required in the design process for the combination module obtained by combining a plurality of components, which contributes to shortening the design time.

In the second embodiment, the components constituting the combination module are standard components, and the input section 1 is configured to allow the user to select the input data consistent with the standard components. Thereby, the combination module satisfying the input data can be provided with the input of one time instead of being input twice, which contributes to shortening the design time.

In the second embodiment, the storage section 2 is configured to further store the component DB 22 registered with the component information pertaining to at least the dimensions and the materials of the components; the constituent component selection section 41 is configured to select the components satisfying the combination conditions of the constituent components given by the constituent component data registered in the combination module DB 21 from the data registered in the component DB 22; the dimension calculation section 42 is configured to calculate the essential dimension data on the basis of the dimensions of the components selected by the constituent component selection section 41 for a combination module specified according to the selected components so as to create the CM information and register the created CM information in the combination module DB 21.

Thus, by registering only the CM type, the constituent component data and the component DB 22, it is possible to create the combination module and it is also possible to save time in creating the combination module in consideration of the combination of the components. Moreover, even a new component is added, by registering incrementally the added component into the component DB 22, it is possible to create the combination module with the component as one of the constituent components in a short time.

In the second embodiment, the construction section 32 is configured to create the display data of the retrieval result screen which is the combination module data containing the identifiers (the model numbers) for identifying the constituent components of the combination module and the display section 5 is configured to display the display data of the retrieval result screen. Thereby, the user can recognize the constituent components of the combination module.

Further in the second embodiment, the construction section 32 is configured to include the CAD data of the combination module registered in the graphics DB 23 in creating the display data of the retrieval result screen and the display section 5 is configured to display the display data of the retrieval result screen. Thereby, since the user can acquire the CAD data of the combination module, it is not necessary to acquire the CAD data of the constituent components piece by piece and assemble them into the assembly drawing, which contributes to improving the design efficiency.

In the “stopper & block” given as an example in the first embodiment and the sub-module “sensor stand” given as an example in the second embodiment, the design (creation) procedures of the combination modules are different. In other words, if the functions of the combination module is different, the essential dimension data thereof and the calculation method of the essential dimension data is different; thereby, the functions fulfilled by the dimension calculation section 42 will become different greatly according to the sub-modules. Moreover, even a CM type belongs to the same sub-module, the shapes of components constituted by the CM type would be different; thereby, the calculation method of the essential dimension data will become different.

Conventionally, the design of a combination module satisfying the essential dimension data is performed with the individual design procedure by the designers according to their individual experiences. In order to fulfill the functions of the dimension calculation section 42, the design procedures are made public by the designers, which makes it possible to standardize the design procedure for each CM type. In other words, it is necessary to determine the standard design procedure on the basis of the design procedures from various designers and determine the functions of the dimension calculation section 42 according to the determined standard procedure. Such operation would be an opportunity for an inexperienced designer to learn design so as to improve the skill of the designer.

In the first embodiment and the second embodiment, the input section 1 and the display section 5 are configured to be included in the apparatus for providing combination module; however, it is acceptable that an interface section having an interface function to a network is disposed in the apparatus for providing combination module, the interface section is connected via a network such as a LAN (Local Area Network) or internet to a terminal device connected to the network. In this case, the terminal device functions as the input section 1 and the display section 5.

In the first embodiment and the second embodiment, the storage section 2 is configured to be included in the apparatus for providing combination module; however, it is acceptable for it to be an external storage device accessible by the apparatus for providing combination module.

1. An apparatus for providing data pertaining to a combination module obtained by combining a plurality of components to a user, comprising:
a display section configured to display the data to the user;
an input section configured to accept data input from the user;
a storage section configured to store a combination module database in which assembly example data pertaining to a plurality of assembly examples of the combination modules is registered, and constituent component data pertaining to combinations of constituent components in the assembly examples and assembly dimension data of the combination modules are registered in association with the assembly example data;
a selection section configured to select a combination module desired by the user from the data registered in the combination module database and the data input by the user;
wherein the assembly dimension data is composed of essential dimension data satisfying a design specification of a combination module required by the user and internal design dimension data containing predetermined dimensions of constituent components of the combination module except the essential dimension data;
the input section is configured to allow the user to input data of one assembly example and allow the user to input only the essential dimension data of the assembly dimension data;
the selection section is provided with a retrieval section configured to retrieve one combination module having dimensions including the essential dimension data input through the input section from the assembly dimension data registered in the combination module database in association with the assembly example data input by the user; and
the retrieval section is configured to present the retrieved combination module data to the user via the display section.

2. The apparatus for providing combination module according to claim 1, wherein the components are standard components; and the input section allows the user to select the input data consistent with the standard components.

3. The apparatus for providing combination module according to claim 1 further comprising:
a component database for registering data pertaining to at least the dimensions and materials of the components, and
a creation section configured to create the assembly dimension data of the combination module database from the data registered in the component database and the constituent component data registered in the combination module database,
wherein
the storage section stores the component database;
the creation section is provided with a constituent component selection section configured to select components satisfying combination conditions of the constituent components given by the constituent component data registered in the combination module database from the data registered in the component database, and a dimension calculation section configured to calculate the essential dimension data on the basis of the dimensions of the components selected by the constituent component selection section for a combination module specified according to the selected components; and
the dimensions including the calculated essential data are registered in the combination module database as the assembly dimension data of the combination module.

4. The apparatus for providing combination module according to claim 3, wherein the creation section is configured to construct the combination module data containing at least identifiers for identifying the constituent components of the combination module retrieved by the retrieval section.

5. The apparatus for providing combination module according to claim 4, wherein
the storage section is configured to further store a graphics database registered with CAD data of the combination module; and
the creation section is configured to include the CAD data of the combination module registered in the graphics database in creating the combination module data.
